(19) United States
(12) Patent Application Publication
(10) Pub. No.: US 2025/0286254 A1
(43) Pub. Date: Sep. 11, 2025

(54) BATTERY PACK WITH REVERSIBLE CONNECTOR AND ZERO VOLT STABILITY

(71) Applicant: American Lithium Energy Corporation, Carlsbad, CA (US)

(72) Inventors: Jiang Fan, San Diego, CA (US); Guang Yang, San Diego, CA (US)

(21) Appl. No.: 19/071,669

(22) Filed: Mar. 5, 2025

Related U.S. Application Data
(60) Provisional application No. 63/561,513, filed on Mar. 5, 2024.

(51) Int. Cl. H01M 50/581; C23F 13/00; H01M 10/0525; H01M 50/213

(52) U.S. Cl. CPC H01M 50/581; C23F 13/005; H01M 10/0525; H01M 50/213; C23F 2213/30; H01M 2200/103

(57) ABSTRACT

A battery pack may include a plurality of battery cells and a reversible memory metal-based connector that transitions between a deformed state to an undeformed state in response to a temperature trigger. For example, the reversible memory metal-based connector may be a clamp, a coil, a tubing, and/or the like. The reversible memory metal-based connector in the deformed state may physically connect two or more of the plurality of battery cells such that an electrical current is able to flow between the two or more battery cells. The reversible memory-metal based connector in the undeformed state is physically disconnected from the two or more battery cells to disrupt a flow of current between the two or more battery cells.

### CROSS REFERENCE TO RELATED APPLICATION

This application claims priority to U.S. Provisional Application No. 63/561,513, entitled “BATTERY PACK WITH REVERSIBLE CONNECTOR AND ZERO VOLT STABILITY” and filed on Mar. 5, 2024, the disclosure of which is incorporated herein by reference in its entirety.

### TECHNICAL FIELD

The subject matter described herein relates generally to battery technology and more specifically to a battery pack with zero-volt stable battery cells interconnected via one or more reversible memory metal-based connectors.

### BACKGROUND

The high energy density and high current output of metal ion battery cells, such as lithium (Li) ion battery cells, mean that metal ion battery cells may be suitable for a variety of high energy and high power applications. However, a metal ion battery cell may be susceptible to internal morphological deformations caused by parasitic reactions that occur during the charging and discharging of the metal ion battery cell. The development of internal morphological deformations may diminish the capacity and cycle life of the metal ion battery cell. Moreover, some internal morphological deformations, such as the formation of dendrites on the electrodes of the metal ion battery cell, may give rise to significant safety hazards.

### SUMMARY

Systems, methods, and articles of manufacture, including battery packs, battery cells, and various components, are provided. In some example embodiments, there is provided a battery pack in which a plurality of zero-volt stable battery cells are interconnected via one or more reversible memory metal-based connectors. The battery pack may include: a plurality of battery cells; and a reversible memory metal-based connector that transitions between a deformed state to an undeformed state in response to a temperature trigger, wherein the reversible memory metal-based connector in the deformed state physically connects two or more of the plurality of battery cells such that an electrical current is able to flow between the two or more battery cells, and wherein the reversible memory-metal based connector in the undeformed state is physically disconnected from the two or more battery cells to disrupt a flow of current between the two or more battery cells.

In some variations, the reversible memory metal-based connector is a clamp. The clamp is in a closed state when the reversible memory metal-based connector is in the deformed state. The clamp is in an open state when the reversible metal-based connector is in the undeformed state.

In some variations, the reversible memory metal-based connector is a coil. The coil is in a coiled state when the reversible memory metal-based connector is in the deformed state. The coil is in an uncoiled state when the reversible metal memory-based connector is in the undeformed state.

In some variations, the reversible memory metal-based connector is a tubing. The tubing is in a compressed state when the reversible memory metal-based connector is in the deformed state. The tubing is in an uncompressed state when the reversible memory metal-based connector is in the undeformed state.

In some variations, the reversible memory metal-based connector is a bar. The bar is in an uncontracted state when the reversible memory metal-based connector is in the deformed state. The bar is in a contracted state when the reversible memory metal-based connector is in the undeformed state. The bar includes one or more weak points that breaks when the reversible memory metal-based connector reverts to its undeformed state.

In some variations, the plurality of battery cells are a plurality of metal ion battery cells.

In some variations, the plurality of battery cells are a plurality of lithium ion (Li+) battery cells.

In some variations, the plurality of battery cells include at least one battery cell having one or more sacrificial electrodes. The one or more sacrificial electrodes decompose while the at least one battery cell is in a low-voltage state or a zero-voltage state to prevent a decomposition of a negative current collector in the at least one battery cell.

In some variations, the reversible memory metal-based connector in the deformed state physically couples an electrode tab of each of the two or more battery cells. The reversible memory metal-based connector physically decouples the electrode tab of the two or more battery cells when the reversible memory metal-based connector transitions to the undeformed state.

In some variations, the reversible memory metal-based connector in the deformed state is inserted through an aperture in an electrode tab of each of the two or more battery cells.

In some variations, the temperature trigger is a temperature determined based on a temperature tolerance of an application associated with the battery pack.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a horizontal cross-sectional view of an example of a battery cell consistent with implementations of the current subject matter;

FIG. 1B depicts a vertical cross-sectional view of an example of a battery cell consistent with implementations of the current subject matter;

FIG. 1C depicts a transparent view of an example of a battery cell consistent with implementations of the current subject matter;

FIG. 2A depicts a horizontal cross-sectional view of another example of a battery cell consistent with implementations of the current subject matter;

FIG. 2B depicts a perspective view of a cross section of another example of a battery cell consistent with implementations of the current subject matter;

FIG. 2C depicts a vertical cross-sectional view of another example of a battery cell consistent with implementations of the current subject matter;

FIG. 3A depicts a perspective view of an example of a jellyroll consistent with implementations of the current subject matter;

FIG. 3B depicts a perspective view of another example of a jellyroll consistent with implementations of the current subject matter;

FIG. 4A depicts an example of a positive electrode and a negative electrode consistent with implementations of the current subject matter;

FIG. 4B depicts another example of a positive electrode and a negative electrode consistent with implementations of the current subject matter;

FIG. 4C depicts another example of a positive electrode and a negative electrode consistent with implementations of the current subject matter

FIG. 5 depicts a cross sectional view of an example of an electrode with a porous current collector consistent with implementations of the current subject matter;

FIG. 6A depicts a cross sectional view of a battery cell illustrating an example of a diffusion pathway consistent with implementations of the current subject matter;

FIG. 6B depicts a cross sectional view of a battery cell illustrating another example of a diffusion pathway consistent with implementations of the current subject matter;

FIG. 7 depicts a flowchart illustrating a process for assembling a battery cell consistent with implementations of the current subject matter;

FIG. 8A depicts a graph illustrating the capacity and direct current resistance (DCR) of an example of a battery cell before and after zero-voltage exposure consistent with implementations of the current subject matter;

FIG. 8B depicts a graph illustrating a voltage profile of an example of a battery cell subjected to zero-voltage exposure consistent with implementations of the current subject matter;

FIG. 8C depicts a graph illustrating the lifecycle of an example of a battery cell subjected to zero-voltage exposure consistent with implementations of the current subject matter;

FIG. 9A depicts a graph illustrating the capacity and direct current resistance (DCR) of another example of a battery cell before and after zero-voltage exposure consistent with implementations of the current subject matter;

FIG. 9B depicts a graph illustrating a voltage profile of another example of a battery cell subjected to zero-voltage exposure consistent with implementations of the current subject matter;

FIG. 9C depicts a graph illustrating the lifecycle of another example of a battery cell subjected to zero-voltage exposure consistent with implementations of the current subject matter;

FIG. 10 depicts a graph illustrating a derivative analysis of capacity verse voltage for examples battery cells with and without a sacrificial electrode consistent with implementations of the current subject matter;

FIG. 11A depicts a graph illustrating the energy dispersive spectroscopy (EDS) spectrum of high nickel lithium nickel manganese cobalt oxide powder consistent with implementations of the current subject matter;

FIG. 11B depicts a graph illustrating the energy dispersive spectroscopy (EDS) spectrum of the positive electrode of a battery cell subjected to zero-voltage exposure and cycling consistent with implementations of the current subject matter;

FIG. 11C depicts a graph illustrating the energy dispersive spectroscopy (EDS) spectrum of the negative electrode of a battery cell subjected to zero-voltage exposure and cycling consistent with implementations of the current subject matter;

FIG. 11D depicts a graph illustrating the energy dispersive spectroscopy (EDS) spectrum of the separator of a battery cell subjected to zero-voltage exposure and cycling consistent with implementations of the current subject matter; and

FIG. 12A depicts a graph illustrating the voltage, capacity, and direct current resistance (DCR) of an example of a commercial 3.5Ah 18650 battery cell before and after zero-voltage exposure;

FIG. 12B depicts a graph illustrating a voltage profile of an example of a commercial 3.5Ah 18650 battery cell subjected to zero-voltage exposure; and

FIG. 12C depicts a graph illustrating the lifecycle of an example of a commercial 3.5Ah 18650 battery cell subjected to zero-voltage exposure.

FIG. 13 depicts an example of a reversible memory metal-based connector for providing an electrical coupling between two or more metal-ion battery cells in a battery pack, in accordance with some example embodiments;

FIG. 14 depicts an example of a reversible memory metal-based connector, in accordance with some example embodiments;

FIG. 15 depicts another example of a reversible memory metal-based connector, in accordance with some example embodiments;

FIG. 16 depicts another example of a reversible memory metal-based connector, in accordance with some example embodiments;

FIG. 17 depicts another example of a reversible memory metal-based connector, in accordance with some example embodiments;

FIG. 18 depicts another example of a reversible memory metal-based connector, in accordance with some example embodiments;

FIG. 19 depicts another example of a reversible memory metal-based connector, in accordance with some example embodiments;

FIG. 20 depicts another example of a reversible memory metal-based connector, in accordance with some example embodiments;

FIG. 21 depicts another example of a reversible memory metal-based connector, in accordance with some example embodiments;

FIG. 22 depicts another example of a reversible memory metal-based connector, in accordance with some example embodiments;

FIG. 23 depicts another example of a reversible memory metal-based connector, in accordance with some example embodiments;

FIG. 24A depicts another example of a reversible memory metal-based connector, in accordance with some example embodiments;

FIG. 24B depicts another example of a reversible memory metal-based connector, in accordance with some example embodiments; and

FIG. 25 depicts another example of a reversible memory metal-based connector, in accordance with some example embodiments.

When practical, similar reference numbers denote similar structures, features, or elements.

### DETAILED DESCRIPTION

A metal ion battery cell, such as a lithium (Li) ion battery cell, may be over discharged when the metal ion battery cell is discharged beyond a minimum voltage. Subjecting a conventional metal ion battery cell to an over discharge (or deep discharge) may destabilize the metal ion battery cell. For example, when a conventional metal ion battery cell is discharged to a low-voltage state or a zero-voltage state, the solid electrolyte interphase (SEI) present within the metal ion battery cell may begin to decompose. The solid electrolyte interphase (SEI) may prevent electrolyte decomposition and sustain electrochemical reactions within the metal ion battery cell by enabling the transport of metal ions (e.g., lithium (Li) ions and/or the like) while blocking the transport of electrons and further reaction between the electrolyte and negative electrode. As such, a degraded solid electrolyte interphase (SEI) may contribute to an irreversible capacity loss at the metal ion battery cell. Moreover, a metal ion battery cell with a degraded solid electrolyte interphase (SEI) may exhibit a higher impendence and is thus able to provide less power to its load because more power is being dissipated as heat by the internal resistance of the metal ion battery cell.

Discharging a conventional metal ion battery cell to a low-voltage state or a zero-voltage state may also cause the negative current collector of the metal ion battery cell to undergo an anodic corrosion, which depletes metal ions from the negative current collector. Metal ions from the negative current collector may dissolve into the electrolyte of the metal ion battery cell, travel through the separator, and accumulate on the positive electrode of the metal ion battery cell. Meanwhile, during a subsequent recharging of the battery cell, the depleted metal ions may again dissolve into the electrolyte before being deposited on the surface of the negative electrode. The resulting change in the internal morphology of the metal ion battery cell, which includes metal dendrites formed by the accumulation of metal ions on the negative electrode, may degrade the capacity of the metal ion battery cell. Moreover, an internal short circuit may develop within the metal ion battery cell when the metal dendrites formed on the surface of the negative electrode puncture the separator and come in contact with the positive electrode of the metal ion battery cell.

Instability at low-voltage or zero-voltage is detrimental for applications in which the metal ion battery cell may be subject to long term storage. For example, even in the absence of active use, the voltage of the metal ion battery cell may diminish due to self-discharge, power consumption by a battery management system, and/or parasitic loads. In other cases, imbalances in a serially connected cluster of metal ion battery cells may inadvertently over discharge one or more of the metal ion battery cells in the cluster. Some measures, such as pre-lithiating the negative electrode of a lithium (Li) ion battery cell, merely counteract the loss of lithium that occurs during the manufacturing process. However, conventional pre-lithiation techniques, such as applying a lithium powder to the surface of the negative electrode, render the negative electrode highly reactive and thus require an inert manufacturing environment (e.g., dry room). Moreover, despite the manufacturing complexity and safety hazards, pre-lithiating the negative electrode of a lithium-ion battery cell does not protect the negative electrode from anodic corrosion when the lithium-ion battery cell is in a low-voltage or a zero-voltage state for an extended period. For example, the lithium-ion battery cell may be pre-lithiated with less than 20% additional lithium in order to compensate for the lithium that is lost during the initial charge and discharge cycle. Pre-lithiating the lithium ion battery cell with more lithium that what could be lost during the first charge and discharge cycle may run the risk of converting the lithium ion battery cell into a lithium metal battery cell. However, pre-lithiating the lithium-ion battery cell with only the lithium that could be lost during the initial charge and discharge cycle leaves the negative current collector unprotected once the residual lithium is consumed. As such, pre-lithiating the lithium ion battery cell alone is not sufficient to protect the negative electrode from corrosion after the initial charge and discharge cycle.

The safety hazards associated with individual battery cells, such as thermal events arising from overcharging and overcurrent, are compounded in battery packs in which numerous battery cells are connected in parallel and/or in series. For example, a typical electric vehicle may include, on average, multiples of thousands of battery cells (e.g., metal ion battery cells such as lithium ion (Li+) battery cells). A thermal event at one battery cell will often propagate quickly to engulf other battery cells in the same and adjacent battery packs, ultimately leading to catastrophic fires and explosions. In some cases, cell-level safety mechanisms, such as thermally activated chemical fuses, may be inadequate for controlling thermal events occurring at the pack level. For instance, the safety mechanism at each individual battery cell may be unable to arrest a large scale, pack-level thermal event involving multiple battery cells. As such, in some implementations of the current subject matter, a battery pack including a plurality of battery cells, whether connected in series and/or in parallel, may be equipped with a pack-level safety mechanism for thwarting the spread of thermal events across multiple battery cells. In some cases, the pack-level safety mechanism may include a reversible memory metal-based connector (RMMC) that provides an electrical connection (or a conduit for electrical current) between the individual battery cells in the battery pack. As described in more details below, the reversible memory metal-based connector (RMMC) may transition between an original (or undeformed) state and a deformed state. While the reversible memory metal-based connector (RMMC) is in the deformed state, the reversible memory metal-based connector (RMMC) may electrically connect the battery cells in the battery pack such that electrical current is able to flow therebetween. In some cases, the reversible memory metal-based connector (RMMC) may provide the electrical connection between individual battery cells by at least being physically coupled with the electrode tabs of the individual battery cells. Contrastingly, when the reversible memory metal-based connector (RMMC) reverts back to its original (or undeformed) state, such as upon exposure to heat (e.g., from a thermal event at one or more battery cells), the reversible memory metal-based connector (RMMC) may become physically decoupled from the electrode tabs of one or more battery cells such that the electrical connection between individual battery cells is interrupted, thus stopping the flow of current therebetween. It should be appreciated that the reversible memory metal-based connector (RMMC) may revert back to its original (or undeformed) state upon reaching a threshold temperature (or trigger temperature). In some cases, the threshold temperature (or trigger temperature) of the reversible memory metal-based connector (RMMC) may be configurable, meaning that the reversible memory metal-based connector (RMMC) may be configured to revert back to its original (or undeformed) state at different temperatures depending on the application. That is, the reversible memory metal-based connector (RMMC) may revert to its original (or undeformed) state at a higher (or lower) temperature that is specific to the temperature tolerance of each application. Moreover, a single battery pack may include one or more reversible memory metal-based connector (RMMC), each of which electrically coupling multiple battery cells. In other words, a single reversible memory metal-based connector (RMMC) may control the flow of current between multiple battery cells. In some cases, a single reversible memory metal-based connector (RMMC) may control the flow of current between some or all of the battery cells in a battery pack.

In some implementations of the current subject matter, in addition to the pack-level safety mechanism described above, individual battery cells in a battery pack may also include cell-level safety mechanisms to reduce (or minimize) the likelihood of thermal events. In particular, in some cases, each individual battery cell may include a safety mechanism that enables the battery cell to be discharged to a low-voltage state or zero-voltage state, at which point the risk of a thermal event arising from overcharging or overcurrent becomes negligible. For example, in some cases, each battery cell in the battery cell may be a metal ion battery cell having one or more sacrificial electrodes configured to improve the stability of the metal ion battery cell in a low-voltage state or a zero-voltage state. The inclusion of the one or more sacrificial electrodes may enable the battery cells to be discharged to and maintained at a low-voltage state or a zero-voltage state without permanent morphological damage, such as the corrosion of the negative current collector in each battery cell. In some cases, the one or more sacrificial electrodes may be formed from a first material having a lower decomposition voltage than a second material forming the negative current collector of the metal ion battery cell. In one example where the negative current collector of the metal ion battery cell is formed from copper (Cu), the sacrificial electrodes may be formed from one or more of zinc (Zn), aluminum (Al), lithium (Li), a lithium (Li) alloy, an oxide, and/or the like.

In some implementations of the current subject matter, the one or more sacrificial electrodes may be incorporated into the metal ion battery cell by being electrically coupled the negative electrode but not the positive electrode of the metal ion battery cell. For example, the one or more sacrificial electrodes may be coupled with the negative electrode of the metal ion battery cell or a metal case of the metal ion battery cell in cases where the metal case of the metal ion battery cell is coupled with the negative electrode. The sacrificial electrodes may prevent a decomposition of the negative current collector and/or the solid electrolyte interphase (SEI) when the metal ion battery cell is in a low-voltage state or a zero-voltage state. For instance, when the metal ion battery cell is in a low-voltage state or a zero-voltage state, the sacrificial electrodes may decompose instead of the negative current collector and/or the solid electrolyte interphase (SEI), thereby preserving the negative current collector and thus the internal morphology of the metal ion battery cell. Even in cases where the dissolved sacrificial electrodes accumulate on the surface of the positive electrode (during the discharging of the battery cell) or on the surface of the negative electrode (during the recharging of the battery cell), the materials forming the sacrificial electrodes may accumulate more uniformly and are thus resistant to forming dendrites on the surfaces of the electrodes. As such, the sacrificial electrodes may preserve the morphology of the battery cell, thus maintaining the capacity and cycle life of the metal ion battery cell even when the metal ion battery cell is discharged to a low-voltage state or a zero-voltage state such as when the metal ion battery cell is subjected to long term storage.

In some implementations of the current subject matter, the metal ion battery cell may include one or more porous current collectors. For example, the negative current collector and/or the positive current collector of the metal ion battery cell may be formed from a porous material such as an expanded metal foil, a perforated foil, or a composite carbon-based foil (e.g., carbon fiber, graphene, and/or the like). The one or more sacrificial electrodes may be incorporated in the metal ion battery cell in a variety of manner including, for example, by being disposed in a center a cylindrical or flat jellyroll formed by winding the positive electrode, negative electrode, and separator of the metal ion battery cell. Alternatively and/or additionally, the sacrificial electrode may be coated on a negative current collector of the metal ion battery cell. The porosity of the current collectors may reduce diffusion length by several orders of magnitude at least because metal ions from the sacrificial electrodes are able to diffuse across the layers of current collectors and electrodes rather than being forced to diffuse along the length of the current collectors and electrodes.

In some implementations of the current subject matter, a battery pack may include multiple metal ion battery cells. In some cases, one or more metal ion battery cells in various embodiments of the battery pack described herein may be configured for zero-volt stability, for example, with the inclusion of one or more sacrificial electrodes. Moreover, in some cases, the metal ion battery cells may be connected, for example, in a series or in parallel, via one or more reversible memory metal-based connectors (RMMC). In some cases, a reversible memory metal-based connector (RMMC) may connect two or more metal ion battery cells in the battery pack through apertures in the electrode tabs of each metal ion battery cell. This configuration may provide for a stable and vibration-tolerant connection between the metal ion battery cells in the battery pack. Moreover, the reversible memory metal-based connector (RMMC) may be restored to its original conformation, for example, with the application of heat. This feature may be especially advantageous when the battery pack is being recycled and reconfigured for a different application.

In some implementations of the current subject matter, a battery pack may include a pack-level safety mechanism to disrupt the flow of current between multiple constituent battery cells, thereby thwarting thermal events that affects (or can potentially affect) multiple battery cells in the battery pack. In some cases, the pack-level safety mechanism may include one or more reversible memory metal-based connectors (RMMC), each of which connecting two or more metal ion battery cells in a battery pack through apertures in the electrode tabs of each metal ion battery cell. For example, in some cases, the reversible memory metal-based connector (RMMC) may include prongs that physically couple with the apertures in the electrical tabs of each metal ion battery cell. In some cases, the reversible memory metal-based connector (RMMC) may be implemented as a clamp or a coil that, while in its deformed state, grips the electrode tabs of two or more battery cells in the battery pack, thus providing an electrical connection therebetween. When the clamp or coil reverts to its original (or undeformed state), the electrode tabs of the two or more battery cells in the battery pack are released to disconnect the electrical connection therebetween. In some cases, the reversible memory metal-based connector (RMMC) may provide a stable and vibration-tolerant connection between two or more batter cells (e.g., metal ion battery cells) in the battery pack. For instance, in some cases, the reversible memory metal-based connector (RMMC) may be in a deformed state in order to provide an electrical connection between the two or more metal ion battery cells in the battery pack. While the reversible memory metal-based connector (RMMC) is in the deformed state, electrical current is able to flow between the two or more metal ion battery cells in the battery pack. Contrastingly, upon exposure to heat, the reversible memory metal-based connector (RMMC) may revert back to its original (or undeformed) state, at which point the two or more metal ion battery cells in the battery pack may become electrically decoupled. While the reversible memory metal-based connector (RMMC) is in its original (or undeformed state), electrical current is unable to flow between the two or more metal ion battery cells in the battery pack. In some cases, the reversible memory metal-based connector (RMMC) may be reverted back to its original (or undeformed) state) when the battery pack being recycled for a different application.

In some implementations of the current subject matter, the reversible memory metal-based connector (RMMC) may also serve as a fuse given its ability to disrupt the flow of electric current between the two or more metal-ion battery cells in the battery pack upon exposure to heat generated, for example, by an external or internal short circuit. In some cases, the reversible memory metal-based connector (RMMC) may be deployed with any format battery cells, including cylindrical cells, prismatic cells, and/or the like. In some cases, the reversible memory metal-based connector (RMMC) may be welded to the header of each battery cell and connected to the battery cells mechanically welding (e.g., laser welding, ultrasonic welding, and/or the like).

In some implementations of the current subject matter, the reversible memory metal-based connector (RMMC) may be rendered in a variety of formats, such as a clamp, a clip, a twisted wire, and/or the like. In some cases, the reversible memory metal-based connector may operate by being contracted, bent, or coiled in its deformed state and uncontracted, unbent, and uncoiled in its original (or undeformed state). The reversible memory metal-based connector enables used battery packs to be easily removed, disassembled, tested, refurbished, and integrated for second life applications. Furthermore, the incorporation of zero-volt stability allows the used battery packs to be discharged to zero volt (or zero energy) prior to shipping and recycling. In some cases, discharging a used battery pack to zero volt (or zero energy) increases the safety profile of the battery pack, as a battery pack in a zero volt (or zero energy) state is less likely to undergo any thermal events.

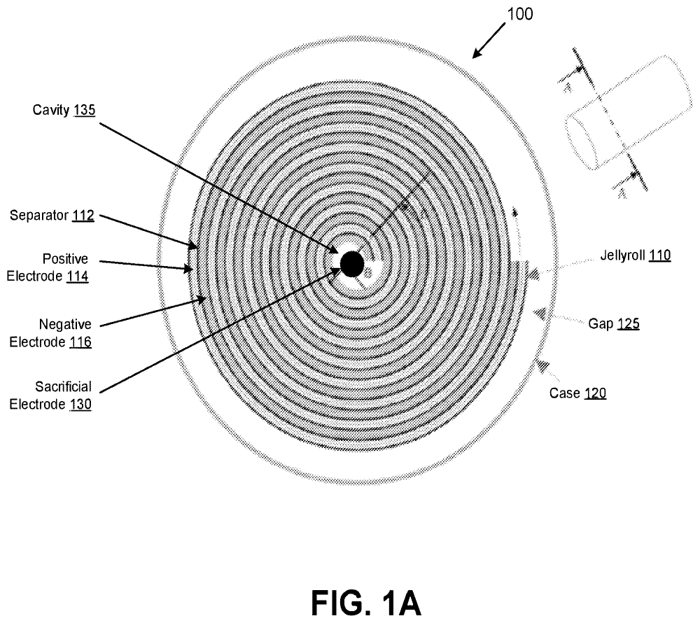

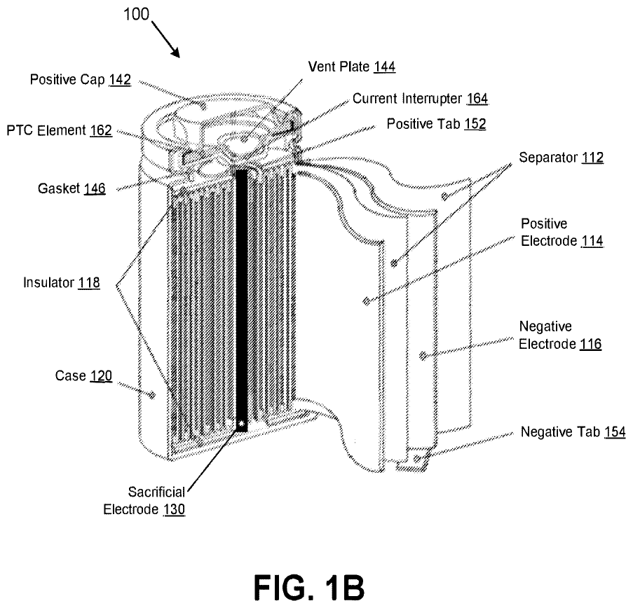

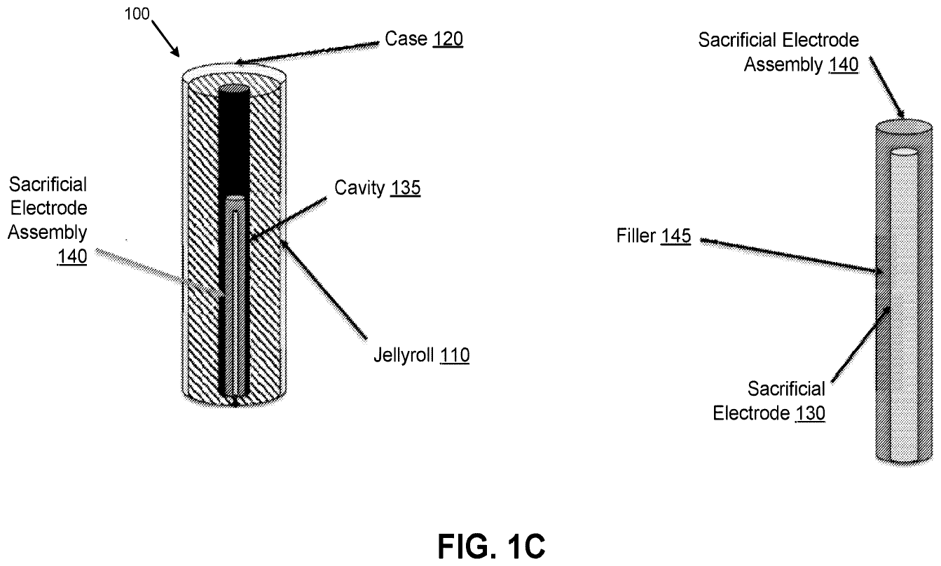

FIGS. 1A-C depict an example of a battery cell 100 consistent with implementations of the current subject matter. The battery cell 100 may be a metal ion battery cell including, for example, a lithium (Li) ion battery cell, a sodium (Na) ion battery cell, a magnesium (Mg) ion battery cell, an aluminum (Al) ion battery cell, and/or the like. Referring to FIGS. 1A-C, the battery cell 100 may include a jellyroll 110 disposed inside a case 120. In the example shown in FIGS. 1A-C, the battery cell 100 may be a cylindrical battery cell. As such, the jellyroll 110 may be substantially cylindrical in shape. The jellyroll 110 may be formed by winding multiple layers of material, each of which corresponding to a component of the battery cell 100. For example, as shown in FIGS. 1A-C, the jellyroll 110 may include a separator 112 interposed between a positive electrode 114 and a negative electrode 116. The surfaces of the jellyroll 110 may not directly contact the interior side wall of the case 120 because inadvertent contact between the case 120, which is typically metallic, the positive electrode 114, and the negative electrode 116 may form an internal short circuit within the battery cell 100. Instead, FIG. 1A shows a gap 125 between the exterior side surface of the jellyroll 110 and the interior side wall of the case 120. Moreover, an insulator 118 may be disposed between the jellyroll 110 and the case 120 to prevent inadvertent contact between the jellyroll 110 and the case 120.

In some implementations of the current subject matter, the battery cell 100 may include one or more sacrificial electrodes such as, for example, the sacrificial electrode 130. In the example shown in FIGS. 1A-C, the sacrificial electrode 130 may be disposed in a cavity 135 at a center of the jellyroll 110. The cavity 135 may be generated after the jellyroll 110 are formed by winding the separator 112, the positive electrode 114, and the negative electrode 116. For example, a jellyroll 110 may be formed by winding the separator 112, the positive electrode 114, and the negative electrode 116 around a mandrel. The mandrel may be removed from the center of the jellyroll 110 to generate the cavity 135 for the insertion of the sacrificial electrode 130. Alternatively, the separator 112, the positive electrode 114, and the negative electrode 116 may be wound around the sacrificial electrode 130 to form the jellyroll 110.

In some implementations of the current subject matter, the sacrificial electrode 130 may be coupled with the negative electrode 116 of the battery cell 100. Alternatively, as is shown in FIG. 1B, the sacrificial electrode 130 may be coupled with the case 120, for example, by being welded to the case 120, which is in turn coupled with the negative electrode 116. In either configuration, the sacrificial electrode 130 may be electrically coupled with the negative electrode 116 but not the positive electrode 114 of the battery cell 100. For example, the separator 112 may provide insulation that prevents the sacrificial electrode 130 from contacting the positive electrode 114. Alternatively and/or additionally, a protective layer (e.g., a polymer film, a ceramic coating, and/or the like) may also be disposed around the exterior surface of the sacrificial electrode 130 and/or the interior surface of the cavity 135 in order to prevent the sacrificial electrode 130 from contacting the positive electrode 114.

Referring to FIG. 1C, in some implementations of the current subject matter, the sacrificial electrode 130 may be a part of a sacrificial electrode assembly 140. As shown in FIG. 1C, the sacrificial electrode assembly 140 may include the sacrificial electrode 130 surrounded by one or more fillers 145 (e.g., an electrolyte and/or the like). Moreover, the battery cell 100 may include additional sacrificial electrodes than the sacrificial electrode 130 (or the sacrificial electrode assembly 140) shown in FIGS. 1A-C. For example, in addition to the sacrificial electrode 130 (or the sacrificial electrode assembly 140) disposed in the center of the jellyroll 110, the battery cell 100 may include a sacrificial electrode applied to an exterior surface of the jellyroll 110 and/or an interior surface of the case 120. In instances where the case 120 is neutral, as in some prismatic cells and large-format cylindrical cells, this configuration can yield a three-electrode cell that allows a user to control the quantity of the sacrificial electrode 130 discharged as well as the time when the sacrificial electrode 130 is discharged.

In some implementations of the current subject matter, the sacrificial electrode 130 may improve the stability of the battery cell 100 in a low-voltage or a zero-voltage state, which may occur when the battery cell 100 is discharged beyond a minimum voltage. For example, the sacrificial electrode 130 may be formed from a first material having a lower decomposition voltage than a second material forming the negative current collector of the battery cell 100. In one example where the negative current collector of the metal ion battery cell is formed from copper (Cu), the sacrificial electrode 130 may be formed from zinc (Zn), aluminum (Al), lithium (Li), a lithium (Li) alloy, an oxide, and/or the like. The sacrificial electrode 130 may also include lithiated silicon (Si), pre-lithiated graphite I, lithium titanate oxide (LTO), lithium tin oxide (LiSnO₂), and/or the like.

In some implementations of the current subject matter, the sacrificial electrode 130 may decompose, for example, through oxidation, when the battery cell 100 is in a low-voltage state or a zero-voltage state. The sacrificial electrode 130 may decompose instead of the negative current collector and/or the solid electrolyte interphase (SEI) of the battery cell 100, thus preserving the capacity and cycle life of the battery cell 100 even when the battery cell 100 is discharged to a low-voltage state or a zero-voltage state such as when the battery cell 100 is subjected to long term storage.

Referring again to FIG. 1B, the battery cell 100 may further include a positive cap 142 on one end of the battery cell 100 and a negative cap on an opposite end of the battery cell 100. The positive electrode 114 may include a positive tab 152 configured to couple, via the positive cap 142, the positive electrode 114 to an external circuit. Furthermore, the negative electrode 116 may include a negative tab 154 configured to couple, via the negative cap, the negative electrode 116 to the external circuit.

In some implementations of the current subject matter, the battery cell 100 may include a primer layer that is permeable to metal ion diffusion. For example, the primer layer may include a polymer capable of absorbing electrolyte in order to provide ionic conductivity for faster diffusion of metal ions from the sacrificial electrode 130. This primer layer may further facilitate the manufacturing of the battery cell 100, particularly where the battery cell 100 includes porous current collectors. For instance, during the coating process in which slurries forming the positive electrode 114 and/or the negative electrode 116 are coated onto the corresponding current collectors, the primer layer may block the pores present in the current collectors and thus prevent the slurries from leaking through the pores during the coating process. The primer layer may also contain one or more protective components or materials configured to respond to excessive voltage, pressure, and/or temperature at the battery cell 100.

Referring again to FIG. 1B, the battery cell 100 may further include a vent plate 144 and a gasket 146 configured to relieve excess pressure buildup within the battery cell 100 by releasing gases that may otherwise cause the battery cell 100 to explode. The battery cell 100 may also include a positive temperature coefficient (PTC) element 162 whose conductivity is inversely proportional to the temperature of the battery cell 100. For example, the positive temperature coefficient element 162 may include one or more positive temperature coefficient material such as, for example, polyethylene (PE) and carbon black, polyvinylidene fluoride (PVDF) and carbon black, an inorganic conductive ceramic (e.g., barium titanium oxide (BaTiO₃) and/or the like) and polyethylene (PE). Because the conductivity of the positive temperature coefficient element 162 decreases when the battery cell 100 is subject to rising temperatures, the positive temperature coefficient element 162 may serve to reduce current flow within the battery cell 100 when the battery cell 100 is subject to rising temperatures. Once the temperature of the battery cell 100 normalizes, the positive temperature coefficient element 162 may return to high conductivity. Alternatively and/or additionally, the battery cell 100 may include a current interrupter 164, which may be a fuse capable of permanently disrupt the flow of current within the battery cell 100 when the battery cell 100 is subject to excessive current, pressure, and/or voltage.

In some implementations of the current subject matter, the sacrificial electrode 130 may be formed by spraying the one or more materials (e.g., a metal, metal alloy, and/or the like) forming the sacrificial electrode 130 onto a surface of the negative current collector and/or the interior surface of the case 120 (if the sacrificial electrode 130 is coupled with the negative electrode 116 through the case 120). Metal spraying is a process in which molten metal (or metal alloy) is sprayed onto a surface to form a coating. For example, molten metal (or metal alloy) may be subjected to a blast of compressed air, which has the joint effect of creating tiny droplets of metal and projecting them towards the surface to be coated. The end result is a solid metal coating on the surface of the current collector and/or the interior surface of the case 120. The thickness of the metal coating may depend on the quantity of layers applied. For instance, the sacrificial electrode 130 may be formed by spraying one or more layers of aluminum (Al), which forms a good, hard barrier but may become passive in mildly corrosive conditions, or zinc (Zn), which forms a poor barrier to erosion or mechanical damage will almost always behave sacrificially. In some instances, the sacrificial electrode 130 may be formed by spraying one or more layers of a metal alloy, such as an aluminum-zinc-indium (Al—Zn—In) alloy, which exhibits the respective advantages of aluminum (Al) and zinc (Zn). The alloy may be heavily aluminum-based (e.g., 95% aluminum (Al)) such that the alloy is much less dense than zinc (Zn) (e.g., 40% the density of zinc (Zn). The sacrificial reaction may involve the loss of three electrons as with pure aluminum (Al) but the aluminum-zinc-indium (Al—Zn—In) alloy is much harder than pure aluminum (Al), which is already harder than zinc (Zn). The inclusion of small quantities of zinc (Zn) and indium (In) keeps the alloy sacrificial in the corrosive environment of the battery cell 100 (e.g., in the presence of chloride ions).

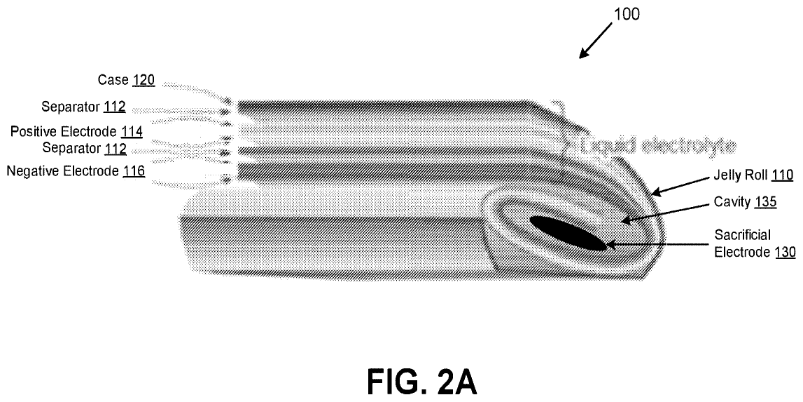

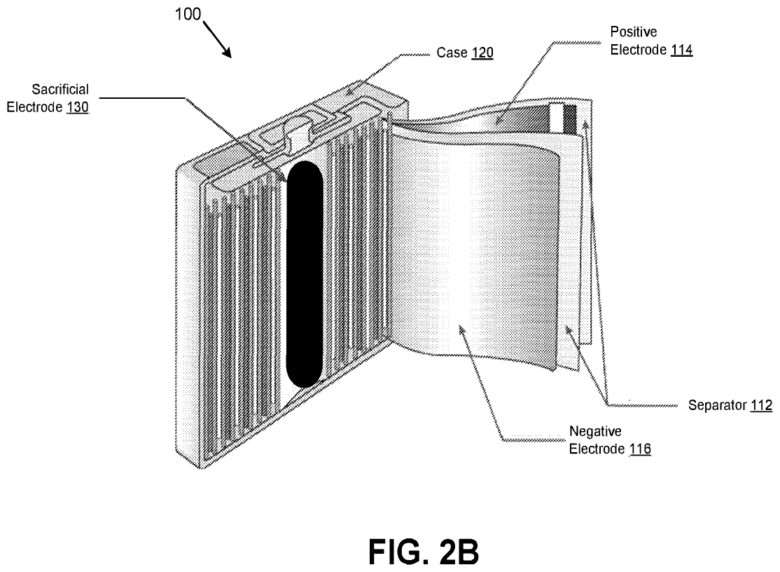

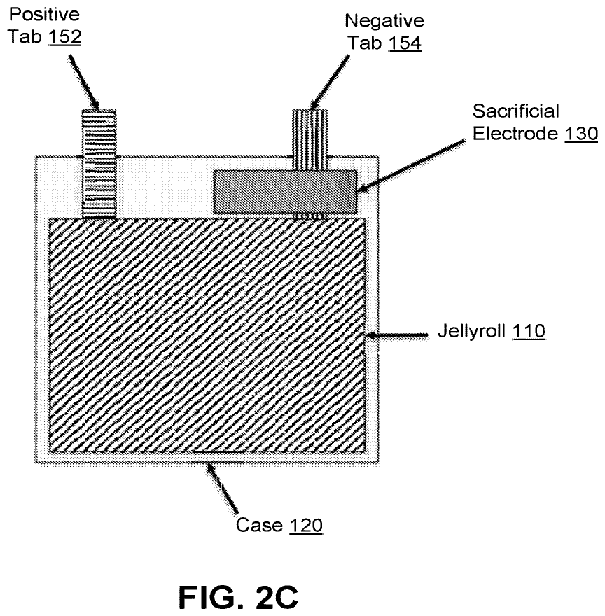

FIGS. 2A-C depict another example of the battery cell 100 consistent with implementations of the current subject matter. The battery cell 100 may be a metal ion battery including, for example, a lithium (Li) ion battery cell, a sodium (Na) ion battery cell, a magnesium (Mg) ion battery cell, an aluminum (Al) ion battery cell, and/or the like. Referring to FIGS. 2A-C, the battery cell 100 may include a jellyroll 110 disposed inside a case 120. In the example shown in FIGS. 2A-C, the battery cell 100 may be a prismatic battery cell. As such, the jellyroll 110 may be a flattened jellyroll, for example, a jellyflat that is substantially an elliptical cylinder in shape. The jellyroll 110 may be formed by winding multiple layers of material, each of which corresponding to a component of the battery cell 100. For example, as shown in FIGS. 2A-C, the jellyroll 110 may include a separator 112 interposed between a positive electrode 114 and a negative electrode 116.

In some implementations of the current subject matter, the battery cell 100 may also include one or more sacrificial electrodes, such as the sacrificial electrode 130 disposed in a cavity 135 at a center of the jellyroll 110. The cavity 135 may be formed within the jellyroll 110 by winding the separator 112, the positive electrode 114, and the negative electrode 116. For example, the jellyroll 110 may be formed by winding the separator 112, the positive electrode 114, and the negative electrode 116 around a mandrel. Removing the mandrel then forms the cavity 135 for the insertion of the sacrificial electrode 130. Alternatively, the separator 112, the positive electrode 114, and the negative electrode 116 may be wound around the sacrificial electrode 130.

In some implementations of the current subject matter, the sacrificial electrode 130 may be coupled with the negative electrode 116 of the battery cell 100. For example, in the example shown in FIG. 2C, the sacrificial electrode 130 may be coupled with the negative tab 154 of the negative electrode 116. Alternatively, as is shown in FIG. 2B, the sacrificial electrode 130 may be coupled with the case 120, for example, by being welded to the case 120, which is in turn coupled with the negative electrode 116. In either configuration, the sacrificial electrode 130 may be electrically coupled with the negative electrode 116 but not the positive electrode 114 of the battery cell 100. Moreover, the sacrificial electrode 130 may improve the stability of the battery cell 100 in a low-voltage or a zero-voltage state, which may occur when the battery cell 100 is discharged beyond a minimum voltage. For instance, the sacrificial electrode 130 may decompose, for example, through oxidation, when the battery cell 100 is in a low-voltage state or a zero-voltage state. The sacrificial electrode 130 may decompose instead of the negative current collector and/or the solid electrolyte interphase (SEI) of the battery cell 100, thus maintaining the capacity and cycle life of the battery cell 100 even when the battery cell 100 is discharged to a low-voltage state or a zero-voltage state such as when the battery cell 100 is subjected to long term storage.

Although not shown in FIGS. 2A-C, the battery cell 100 may also include one or more protective mechanisms for responding to excessive voltage, pressure, and/or temperature at the battery cell 100. For example, the battery cell 100 may include a primer layer as well as a vent plate and a gasket configured to relieve excess pressure buildup within the battery cell 100 including by releasing gases that may otherwise cause the battery cell 100 to explode. The battery cell 100 may also include a positive temperature coefficient (PTC) element whose conductivity is inversely proportional to the temperature of the battery cell 100. Because the conductivity of the positive temperature coefficient element decreases when the battery cell 100 is subject to rising temperatures, the positive temperature coefficient element may serve to reduce current flow within the battery cell 100 when the battery cell 100 is subject to rising temperatures. The positive temperature coefficient element may return to high conductivity when the temperature of the battery cell 100 normalizes. Alternatively and/or additionally, the battery cell 100 may include a current interrupter, which may be a fuse capable of permanently disrupt the flow of current within the battery cell 100 when the battery cell 100 is subject to excessive current, pressure, and/or voltage.

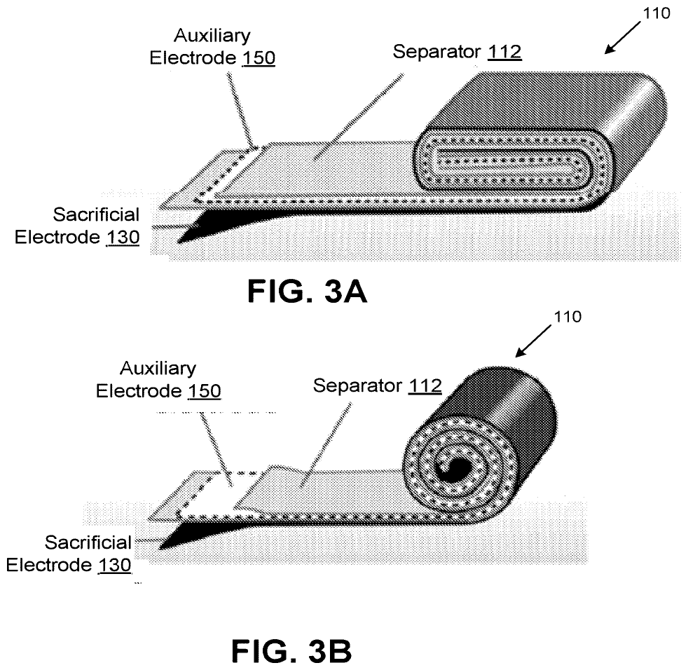

FIGS. 3A-B depict examples of the jellyroll 110 of the battery cell 100 consistent with implementations of the current subject matter. For example, the example of the jellyroll 110 shown in FIG. 3A is a jellyflat that is substantially an elliptical cylinder in shape whereas the example of the jellyroll 110 shown in FIG. 3B is substantially cylindrical in shape. As shown in FIGS. 3A-B, the jellyroll 110 may be formed by winding multiple layers of material, each of which corresponding to a component of the battery cell 100. For instance, the jellyroll 110 may include the separator 112 interposed between the positive electrode 114 and the negative electrode 116. Moreover, as shown in FIGS. 3A-B, the jellyroll 110 may include the sacrificial electrode 130 as well as an auxiliary electrode 150.

In some implementations of the current subject matter, the sacrificial electrode 130 may be coupled with the negative electrode 116 of the battery cell 100. In the examples of the jellyroll 110 shown in FIGS. 3A-B, a first layer of material corresponding to the sacrificial electrode 130 may be applied directly to the surface of a second layer of material corresponding to the negative current collector of the battery cell 100. Moreover, a third layer of material corresponding to the auxiliary electrode 150 may be interface directly with the first layer of material corresponding to the sacrificial electrode 130. However, the auxiliary electrode 150 may be isolated from the positive electrode 114 and the negative electrode 116 of the battery cell 100. The auxiliary electrode 150 may be configured to accept metal ions depleted from the sacrificial electrode 130, for example, when the battery cell 100 is in a low-voltage state or a zero-voltage state. Examples of material forming the auxiliary electrode 150 include cobalt oxide (CoO), nickel oxide (NiO), copper oxide (CuO), iron oxide, manganese oxide (MnO₂), tin oxide (e.g., SnO, SnO₂, and/or the like), iron sulfide (FeS), and nickel phosphorus (NiP).

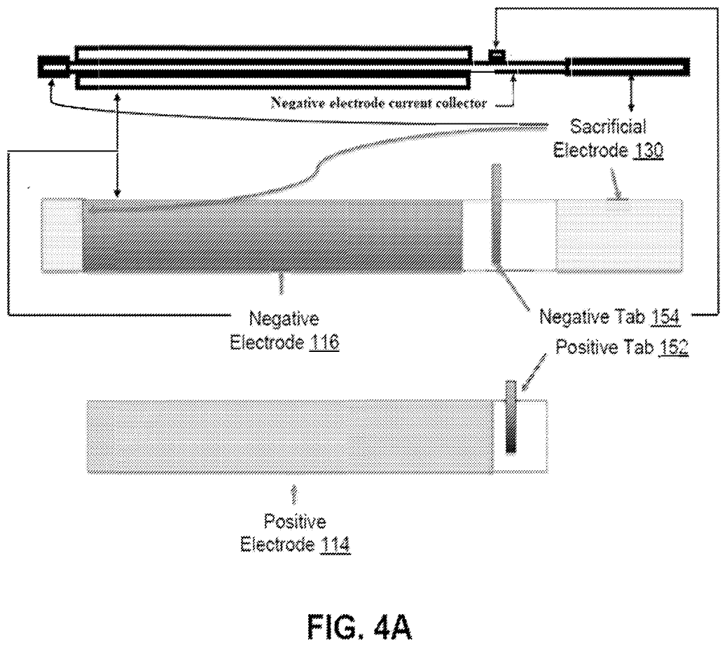

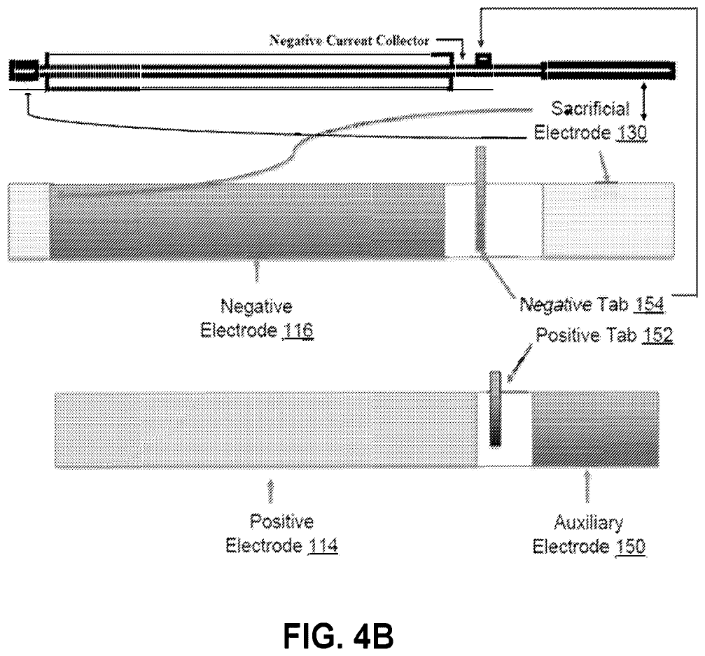

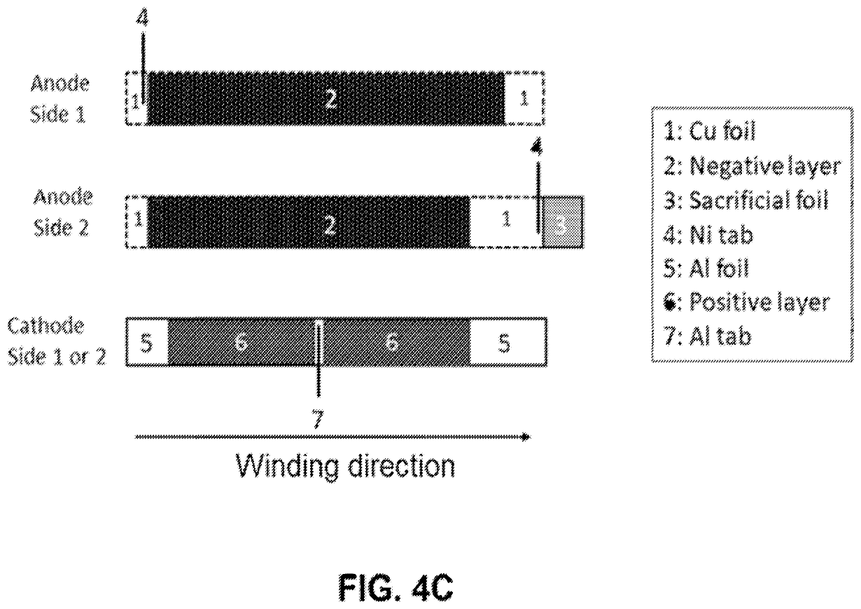

FIGS. 4A-C depict examples of the positive electrode 114 and the negative electrode 116 of the battery cell 100 consistent with implementations of the current subject matter. In the examples of the negative electrode 116 shown in FIGS. 4A-B, a first material corresponding to the negative electrode 116 and a second material corresponding to the sacrificial electrode 130 (in sheet form) may be ultrasonically welded or coated alternately onto the surface of a third material corresponding to the negative current collector of the battery cell 100. In some cases, a first material corresponding to the sacrificial electrode 130 (e.g., in powder form) may be mixed with a second material corresponding to the negative electrode 116 before the mixture is coated onto the surface of the third material corresponding to the negative current collector of the battery cell 100. Meanwhile, FIG. 4B shows an example of the positive electrode 114 in which a first material corresponding to the positive electrode 114 and a second material corresponding to the auxiliary electrode 150 are coated alternately onto the surface of a third material corresponding to the positive current collector of the battery cell 100.

Referring now to FIG. 4C, the first material corresponding to the negative electrode 116 of the battery cell 100 may be coated on one or both side of the third material corresponding to the negative current collector of the battery cell 100. In the example shown in FIG. 4C, the third material forming the negative current collector may be copper (Cu) while the negative tab 154 may be formed from nickel (Ni). Meanwhile, the first material corresponding to the positive electrode 114 of the battery cell 100 may be coated on either surface of the third material corresponding to the positive current collector of the battery cell 100. In the example shown in FIG. 4C, the third material forming the positive current collector may be aluminum (Al) while the positive tab 152 may also be formed from aluminum (Al).

In some example embodiments, the second material forming the sacrificial electrode 130 may include one or more metals and/or metal alloys. Examples of the second material include lithium salts and other compounds with a lower decomposition voltage than the metal forming the negative electrode (e.g., lithium (Li), sodium (Na), magnesium (Mg), aluminum (Al), and/or the like). For example, the second material may include one or more of chromium (Cr), iron (Fe), tin (Sn), lead (Pb), aluminum (Al), lithiated silica oxide (e.g., Li₂Si₂O₅, Li₂SiO₃, LiSiO₄, Li₂O, Li₁₂Si₃, Li₁₃Si₄, LiSnO₃, and/or the like), magnesium aluminum alloy (MgAl), magnesium titanium (MgTi), calcium magnesium (CaMg), zinc (Zn), and magnesium (Mg) based alloys, and some potential conductive polymers or composites that have low decomposition voltage than Copper (Cu). Examples of conductive polymers include polyacetylene (PA), polyaniline (PANI), polypyrrole (PPy), polythiophene (PTH), poly (para-phenylene) (PPP), poly (phenylenevinylene) (PPV), and polyfuran (PF).

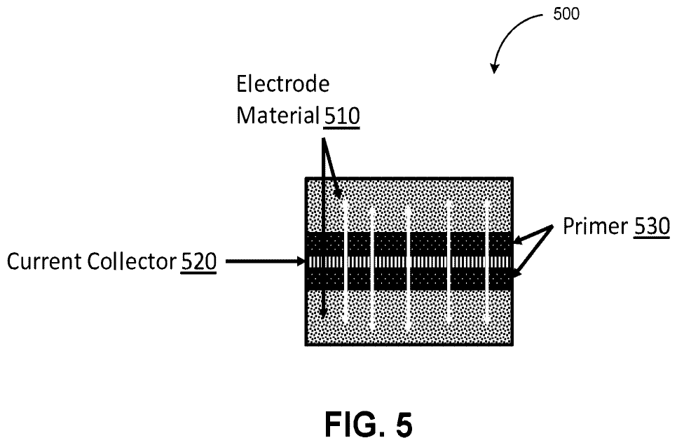

FIG. 5 depicts a cross sectional view of an example of an electrode 500 with a porous current collector consistent with implementations of the current subject matter. As shown in FIG. 5, the electrode 500 may include a current collector 520 disposed between two layers of an electrode material 510. The electrode 500 may implement, for example, the positive electrode 114 and/or the negative electrode 116 of the examples of the battery cell 100 shown in FIGS. 1A-C and 2A-C.

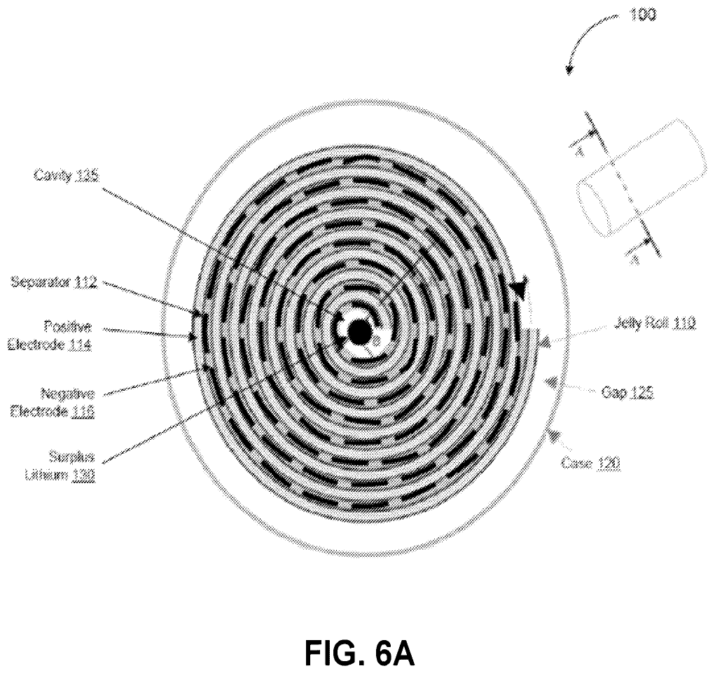

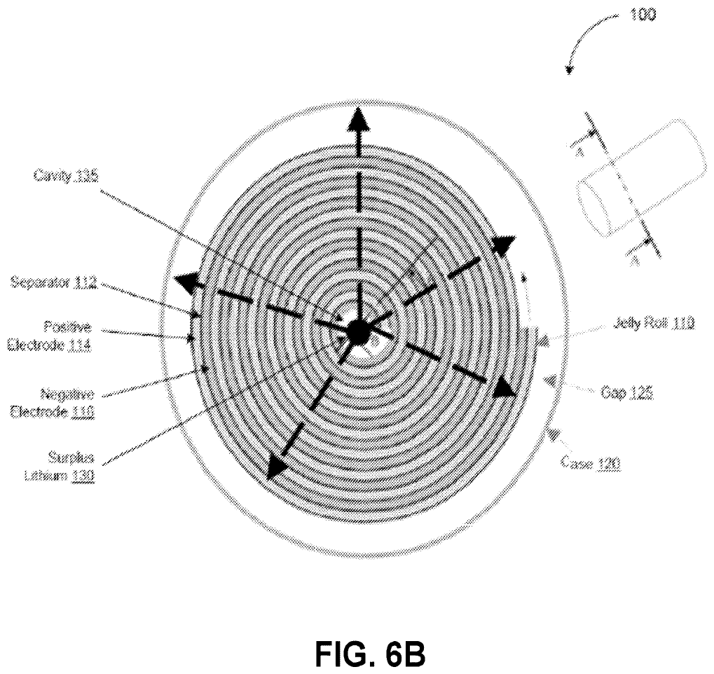

In some implementations of the current subject matter, the current collector 520 may be a porous current collector. That is, the current collector 520 may be a metallic foil (e.g., a copper (Cu) foil, an aluminum (Al) foil, and/or the like) having a plurality of pores, which shorten a diffusion pathway of metal ions (e.g., lithium (Li) ions and/or the like) by at least providing a passageway through the current collector 520. To further illustrate, FIGS. 6A-B depict a cross sectional view of the battery cell 100 illustrating different examples of a diffusion pathway consistent with implementations of the current subject matter. FIG. 6A depicts the diffusion pathway (shown as a dashed line) of metal ions in a variation of the battery cell 100 formed to include a non-porous current collector. Contrastingly, FIG. 6B depicts the diffusion pathway (shown as dashed lines) of metal ions in another variation of the battery cell 100 formed to include a porous current collector such as, for example, the current collector 520.

Referring to FIGS. 6A-B, the inclusion of a porous current collector may shorten the diffusion pathway of metal ions. For instance, while a non-porous current collector may force metal ions to travel along each spiral of the jellyroll 110, a porous current collector may allow metal ions to penetrate through the layers of the jellyroll 100. In doing so, the porous current collector may prevent the formation of a gradient in which a disproportionately high concentration of metal ions aggregates towards a center of the jellyroll 110. Instead, with a porous current collector, metal ions, for example, from the sacrificial electrode 130, may radiate outward evenly from a center of the jellyroll 110.

Nevertheless, the porosity of the current collector 520 may also render the current collector 520 penetrable to other substances including, for example, the slurries forming the electrode material 510. Accordingly, in the example shown in FIG. 5, the electrode 500 may further include a primer layer 530, which may be disposed on the current collector 520 prior to the application of the slurries forming the electrode material 510. The primer layer 530 may be configured to at least prevent a leakage of the slurries through the pores present in the current collector 520.

In some implementations of the current subject matter, the primer layer 530 may further include one or more protective components and/or materials configured to respond to an excessive voltage, pressure, and/or temperature. For example, the primer layer 530 may include a positive temperature coefficient material (e.g., polyethylene (PE) and carbon black, polyvinylidene fluoride (PVDF) and carbon black, an inorganic conductive ceramic (e.g., barium titanium oxide (BaTiO₃) and/or the like) and polyethylene (PE)) whose conductivity is inversely proportional to the temperature of the battery cell 100. Alternatively, the primer layer 530 may include a material that responds to an excessive voltage, pressure, and/or temperature by creating a nonconductive gap between the current collector 520 and one or more layers of the electrode material 510. For instance, the primer layer 530 may generate a gas and/or a liquid that further transitions to a gas when exposed to an excessive voltage, pressure, and/or temperature. The gas may generate the nonconductive gap by at least causing a delamination between the electrode material 510 and the current collector 520. Alternatively and/or additionally, the gas and/or the liquid may generate the nonconductive gap by at least decomposing at least a portion of the electrode material 510.

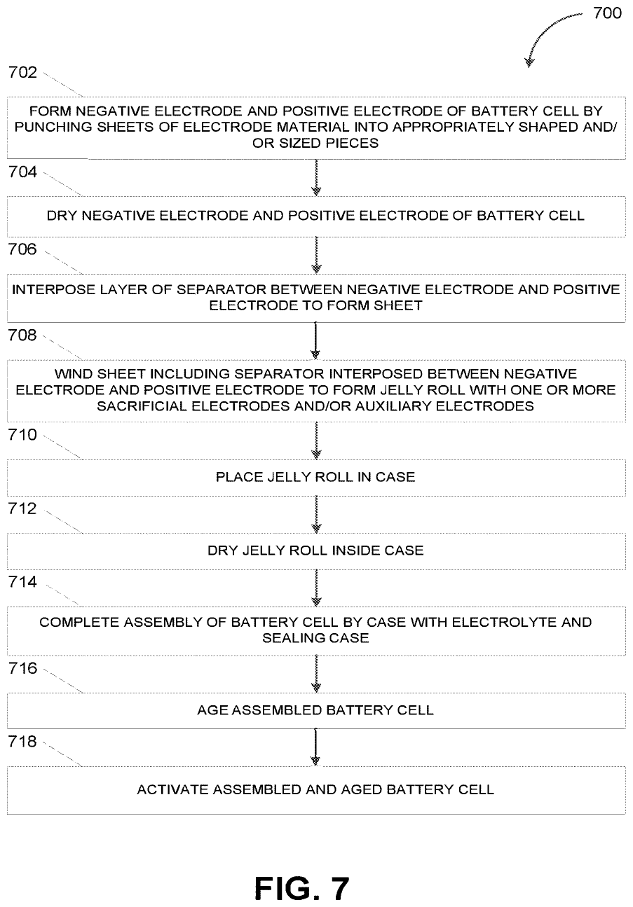

FIG. 7 depicts a flowchart illustrating a process 700 for assembling a battery cell consistent with implementations of the current subject matter. Referring to FIGS. 1A-C, 2A-C, 3A-B, 4A-B, 5, and 7, the process 700 may be performed to form, for example, the battery cell 100.

The negative electrode and positive electrode of the battery cell may be formed by punching sheets of electrode material into appropriately shaped and/or sized pieces (702). For instance, sheets of positive electrode material and/or negative electrode material may be punched into appropriately shaped and/or sized pieces using an electrode tab. The negative electrode and the positive electrode of the battery cell may be dried (704). For example, the positive electrode of the battery cell may be dried at 125° C. for 10 hours while the negative electrode of the battery cell may be dried at 140° C. for 10 hours.

A layer of separator may be interposed between the positive electrode and the negative electrode to form a sheet (706). For instance, a layer of separate may be laminated the positive electrode and the negative electrode of the battery cell to form a sheet. The sheet including the separator interposed between the positive electrode and the negative electrode may be wound to form a jellyroll with one or more sacrificial electrodes and/or auxiliary electrodes (708). In some implementations of the current subject matter, the sacrificial electrode may be disposed inside a cavity of the battery cell. For example, the sheet including the separator interposed between the positive electrode and the negative electrode may be wound around a mandrel. The mandrel may be removed from the center of the jellyroll to form the cavity for the insertion of the sacrificial electrode. Alternatively, the sacrificial electrode may be coated on a surface of the negative current collector of the battery cell. For instance, the first material corresponding to the negative electrode and the second material corresponding to the sacrificial electrode be coated alternately onto the surface of the third material corresponding to the negative current collector of the battery cell. Meanwhile, the first material corresponding to the positive electrode and the second material corresponding to the auxiliary electrode may be coated alternately onto the surface of the third material corresponding to the positive current collector of the battery cell. With either configuration, the sacrificial electrode may be coupled with the negative electrode of the battery cell but not the positive electrode of the battery cell such that the sacrificial electrode may decompose to preserve the negative current collector and the solid electrolyte interphase (SEI) at the negative electrode of the battery cell when the battery cell is discharged to a low-voltage state or a zero-voltage state.

The jellyroll may be placed in a case (710). For instance, the flat jellyroll formed in operation 708 may be placed inside a metallic (e.g., aluminum (Al)) case. The jellyroll may be dried inside the case (712). For example, the flat jellyroll inside the case may be dried at 70° C. for 10 hours. The case may be filled with electrolyte and sealed to complete the assembly of the battery cell (714).

The assembled battery cell may be aged (716). For instance, the battery cell formed in operation 714 can be aged for 36 hours. The assembled and aged battery cell may be activated (718). For example, the battery cell may be activated by undergoing a formation process in which the battery cell is subject to a controlled charge and discharge cycle configured to activate the chemical components of the battery cell. This formation process may require the battery cell to be charged by being exposed to a gradually increasing current instead of a constant current such that the buildup of voltage within the battery cell is gradual.

### Sample Cell I

The positive electrode of Sample Cell I may be formed by dissolving a certain quantity of polyvinylidene difluoride (PVDF) in N-methylpyrrolidone (NMP) to prepare an 8% polymer solution. A certain quantity of carbon black may be added to the 8% polymer solution and mixed for 30 minutes at 6500 revolutions-per-minute to form a slurry. A certain quantity of high nickel lithium nickel manganese cobalt oxide may be added the slurry and mixed for 30 minutes at 6500 revolutions-per-minute with additional N-methylpyrrolidone (NMP) added for adjusting the viscosity to achieve a flowable slurry. The flowable slurry may be coated onto an aluminum (Al) foil (e.g., 15-μm aluminum foil) using an automatic coating machine with the first heat zone set to approximately 80° C. and the second heat zone set to approximately 130° C. to evaporate the N-methylpyrrolidone (NMP). The positive electrode of Sample Cell I may then be formed by compressing the aluminum (Al) foil coated with the slurry to a target thickness and cutting to a target width (e.g., 56 millimeters). A positive tab may be welded to a mass free zone, for example, at the center of the positive electrode.

The negative electrode of Sample Cell I may be formed by dissolving a certain quantity of binder in deionized water and then a conductive additive is added and mixed for 30 minutes at 6500 revolutions-per-minute. Silicon (Si)/Silica oxide (SiO) and a carbon composite may be added to the resulting solution and mixed for 60 minutes at 6500 revolutions-per-minute. Additional water may be added to adjust the viscosity and form a flowable slurry. The slurry may then be coated on to a copper (Cu) foil (e.g., 9-μm thick copper foil) using an automatic coater. The negative electrode of Sample Cell I may be formed by compressing the copper (Cu) foil coated with the slurry to a target thickness and cutting to a target width (e.g., 58 millimeters). Zinc (Zn) foil (e.g., (˜0.025-millimeter zinc foil) corresponding to the sacrificial electrode may be welded (e.g., by ultrasonic welding) to the header or tail of the mass free zone (or negative current collector Cu foil) of negative electrode depending on the desired configuration of Sample Cell I. One or more negative tabs may be welded to the mass free zone of the negative electrode of Sample Cell I.

The jellyroll of Sample Cell I may be formed by winding the positive electrode, the separator, and the negative electrode using, for example, a winding machine. The jellyroll may be inserted into a case which may be, for example, a metal case, a soft pouch, and/or the like. One of the negative tabs may be welded to the case while the positive tab may be welded to the header of Sample Cell I, for example, by laser welding. The unfinished Sample Cell I may be dried at 80° C. for at least 12 hours before the dried Sample Cell I is filled with electrolyte and crimped. Sample Cell I may be aged for 24 hours at room temperature and before undergoing a formation process. For example, the average open circuit voltage (OCV) and impedance of Sample Cell I at 1 kilohertz (KHz) may be ˜0.70 volts and ˜19 milliohms respectively. Sample Cell I may be formed by being charged at C/40 with 300 milliampere hours (mAh) and then to 4.2V at the relatively high rate before being aged for 7 days at room temperature.

Sample Cell I may be tested for its capacity, direct current resistance (DCR), and cycle life before and after zero-voltage exposure. To test Sample Cell I for its capacity and direct current resistance (DCR), Sample Cell I may be rested for 2 hours before being charged at a constant current and constant voltage (CC-CV) at C/5 to 4.4 volts until C/20. Once charged, Sample Cell I may be rested for 10 minutes before being discharged at a constant current (CCD) at C/2 for 5 minutes to approximately 95% state of charge (SOC). A first voltage measurement V₁ and current measurement I₁ may be made 10 seconds prior to the end of the discharge. Sample Cell I may again be subjected to a constant current discharge (CCD) at C/5 for 1 minute before a second voltage measurement V₂ and current measurement I₂ may be made 10 seconds into the second discharge. The direct current resistance (DCR) of Sample Cell I at 95% state of charge (SOC) may correspond to DCR_{95% SOC}=|(V₂−V₁)/(I₂−I₁)|.

Sample Cell I may again be subjected to a constant current discharge (CCD) at C/2 for 54 minutes to reach approximately a 50% state of charge (SOC). A third voltage measurement V₂ and current measurement I₃ may be performed 10 seconds prior to the end the discharge. Sample Cell I may be subjected to constant current discharge (CCD) at C/5 for 1 minute before a fourth voltage measurement V₄ and current measurement I₄ is performed 10 seconds into this discharge. The direct current resistance of Sample Cell I at 50% state of charge (SOC) may correspond to DCR_{50% SOC}=|(V₄−V₃)/(I₄−I₃)|.

Sample Cell I may be subjected again to a constant current discharge (CCD) at C/2 for 36 minutes to reach approximately a 20% state of charge (SOC). A fifth voltage measurement V₅ and current measurement Is may be performed 10 seconds prior to the end of this discharge. Sample Cell I may then be subjected to a constant current discharge (CCD) at C/5 for 1 minute before a sixth voltage measurement V₆ and current measurement I₆ is performed approximately 10 seconds into this discharge. The direct current resistance (DCR) of Sample Cell I at 20% state of charge may correspond to DCR_{20% SOC}=|(V₆−V₅)/(I₆−I₅)|. The discharge capacity/energy, coulombic/energy efficiency, and direct current resistance (DCR) of Sample Cell I may be recorded.

The cycle life at 40% depth of discharge (DOD) for Sample Cell I may be determined by the first resting Sample Cell I for 2 hours. Sample Cell I may be charged at a constant current and constant voltage (CC-CV) at C/5 to 4.4 volts until <C/20. The charged Sample Cell I may be subjected to a constant current discharge (CCD) at C/1.5 for 35 minutes to reach a 40% depth of discharge (DOD). At this point, Sample Cell I may again be charged at a constant current at C/2.25 for 65 minutes before being discharged at a constant current. The charging and discharging of Sample Cell I may be repeated until Sample Cell I exhibits an end-of-discharge voltage (EODV) of 2.5 volts. The capacity of Sample Cell I at 20° C. and its direct current resistance (DCR) may be tested every 200 cycles.

The cycle life at 100% depth of discharge (DOD) for Sample Cell I may be determined by the first resting for 2 hours. Sample Cell I may be charged at a constant current and constant voltage (CC-CV) at C/3 to 4.4 volts until <C/20, rested for 10 minutes, discharged at a constant current (CCD) at C/5 to 2.5 volts, and rested for 30 minutes. Sample Cell I may be repeated charged and discharged until Sample Cell I is at 80% capacity.

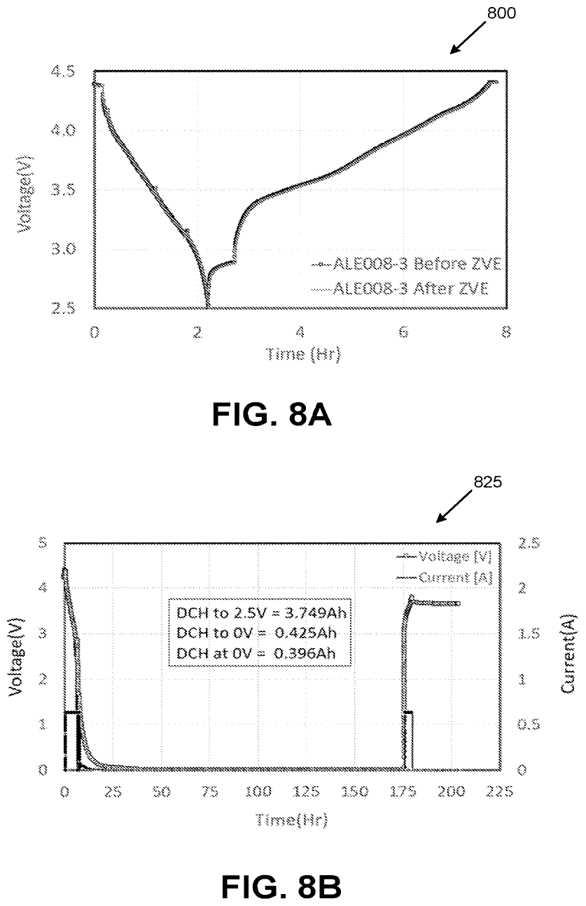

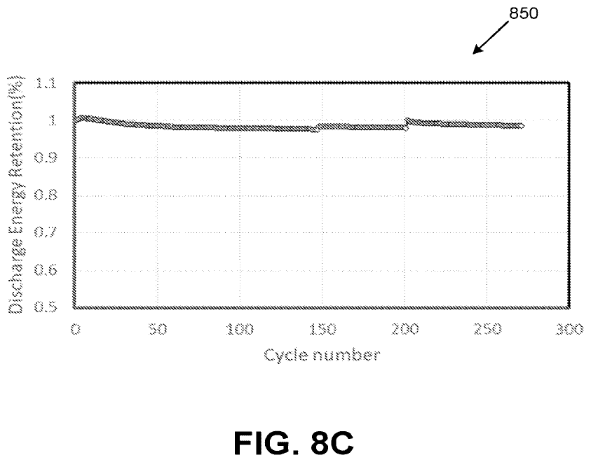

The response of Sample Cell I to zero-voltage exposure (ZVE) may be determined by measuring the initial 20° C. capacity and direct current resistance (DCR) of Sample Cell I. Sample Cell I may then be discharged at a constant current and constant voltage (CC-CV) at C/5 to 4.4 volts until <C/20, rested for 10 minutes, discharged at a constant current (CCD) at C/5 to 2.5 volts, rested for 30 minutes, discharged at a constant current (CCD) at C/5 to 0 volts, and further discharged 20 ohms while at 0 volts for 7 days. Thereafter, Sample Cell I may be charged at a constant current and constant voltage (CC-CV) to 3.8 volts at C/5 before being rested for 24 hours. The 20° C. capacity and direct current resistance (DCR) of Sample Cell I may be determined at this point. Table 1 below depicts a comparative analysis of the capacity and direct current resistance (DCR) of Sample Cell I before and after zero-voltage exposure (ZVE). FIG. 8A depicts a graph 800 illustrating the capacity and direct current resistance (DCR) of Sample Cell I before and after zero-voltage exposure (ZVE). As shown in Table 1 and FIG. 8A, the capacity-time profile of Sample Cell I is substantially the same before and after zero-voltage exposure (ZVE). The discharge capacity of Sample Cell I is 3.717 ampere hours before zero-voltage exposure (ZVE) and 3.713 ampere hours after zero-voltage exposure (ZVE), representative of a loss of ˜0.123%. The direct current resistance (DCR) at 95%, 50%, and 20% state of charge also exhibits little change after zero-voltage exposure (ZVE).

TABLE 1

| Parameter | Before ZVE | After ZVE | Δ(%) |
|---|---|---|---|
| Charge Capacity (Ah) | 3.714 | 3.715 | 0.026 |
| Discharge Capacity (Ah) | 3.717 | 3.713 | −0.123 |
| Charge Energy (Wh) | 14.081 | 14.085 | 0.029 |
| Discharge Energy (Wh) | 12.83 | 12.81 | −0.16 |
| Coulombic Efficiency (%) | 100.09 | 99.94 | −0.14 |
| Energy Efficiency (%) | 91.17 | 90.99 | −0.19 |
| DCR_95% SOC (mΩ) | 31.89 | 32.07 | 0.57 |
| DCR_50% SOC (mΩ) | 30.45 | 31.26 | 2.66 |
| DCR_20% SOC (mΩ) | 40.45 | 38.28 | −5.3 |

FIG. 8B depicts a graph 825 illustrating a voltage-time profile of Sample Cell I while Sample Cell I is subjected to 7 days of zero-voltage exposure at 20 ohms. The discharge capacity of Sample Cell I is 3.749 ampere hours from 4.4 volts to 2.5 volts, 0.425 ampere hours from 2.5 volts to 0 volts, and 0.396 ampere hours at 0 volts. The deep discharge of Sample Cell I released 0.821 ampere hours, resulting in a total discharge capacity of 4.57 ampere hours. The zero-voltage exposure therefore contributed a ˜21.89% change in the discharge capacity of Sample Cell I. FIG. 8C depicts a graph 850 illustrating the cycle life of Sample Cell I after Sample Cell I is subjected to zero-voltage exposure (ZVE) for 7 days at 20 ohms. As shown in FIG. 8C, the discharge energy retention of Sample Cell I is 98.7% after 270 cycles. Moreover, Sample Cell I exhibited an energy loss of only 1.3% after cycling.

### Sample Cell II

Sample Cell II is a baseline battery cell without a sacrificial electrode to preserve its capacity and cycle life while Sample Cell II is in a low-voltage state or zero-voltage state. The positive electrode of Sample Cell II may in the same manner as the positive electrode of Sample Cell I, which includes dissolving a certain quantity of polyvinylidene difluoride (PVDF) in N-methylpyrrolidone (NMP) to prepare an 8% polymer solution. A certain quantity of carbon black may be added to the 8% polymer solution and mixed for 30 minutes at 6500 revolutions-per-minute to form a slurry. A certain quantity of high nickel lithium nickel manganese cobalt oxide may be added the slurry and mixed for 30 minutes at 6500 revolutions-per-minute with additional N-methylpyrrolidone (NMP) added for adjusting the viscosity to achieve a flowable slurry. The flowable slurry may be coated onto an aluminum (Al) foil (e.g., 15-μm aluminum foil) using an automatic coating machine with the first heat zone set to approximately 80° C. and the second heat zone set to approximately 130° C. to evaporate the N-methylpyrrolidone (NMP). The positive electrode of Sample Cell II may then be formed by compressing the aluminum (Al) foil coated with the slurry to a target thickness and cutting to a target width (e.g., 56 millimeters). A positive tab may be welded to a mass free zone, for example, at the center of the positive electrode.

The negative electrode of Sample Cell II may be formed by dissolving a certain quantity of binder in deionized water and then a conductive additive is added and mixed for 30 minutes at 6500 revolutions-per-minute. Silicon (Si)/silica oxide (SiO) and a carbon composite may be added to the resulting solution and mixed for 60 minutes at 6500 revolutions-per-minute. Additional water may be added to adjust the viscosity and form a flowable slurry. The slurry may then be coated on to a copper (Cu) foil (e.g., 9-μm thick copper foil) using an automatic coater. The negative electrode of Sample Cell I may be formed by compressing the copper (Cu) foil coated with the slurry to a target thickness and cutting to a target width (e.g., 58 millimeters). One or more negative tabs may be welded to the mass free zone of the negative electrode of Sample Cell II. As noted, Sample Cell II is a baseline cell that is formed without the sacrificial electrode present in Sample Cell I.

The jellyroll of Sample Cell II may be formed by winding the positive electrode, the separator, and the negative electrode using, for example, a winding machine. The jellyroll may be inserted into a case which may be, for example, a metal case, a soft pouch, and/or the like. One of the negative tabs may be welded to the case while the positive tab may be welded to the header of Sample Cell II, for example, by laser welding. The unfinished Sample Cell II may be dried at 80° C. for at least 12 hours before the dried Sample Cell II is filled with electrolyte and crimped. Sample Cell II may be aged for 24 hours at room temperature and before undergoing a formation process. For example, the open circuit voltage (OCV) and impedance of Sample Cell II at 1 kilohertz may be ˜0.7 volts and ˜19 milliohms respectively. Sample Cell II may be formed by being charged at C/40 with 300 milliampere hours (mAh) before being aged for 7 days at room temperature.

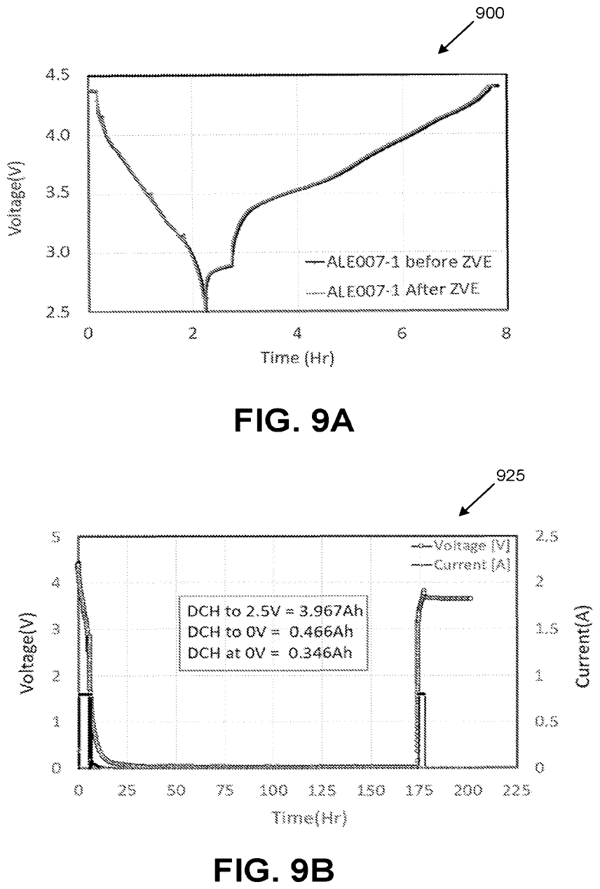

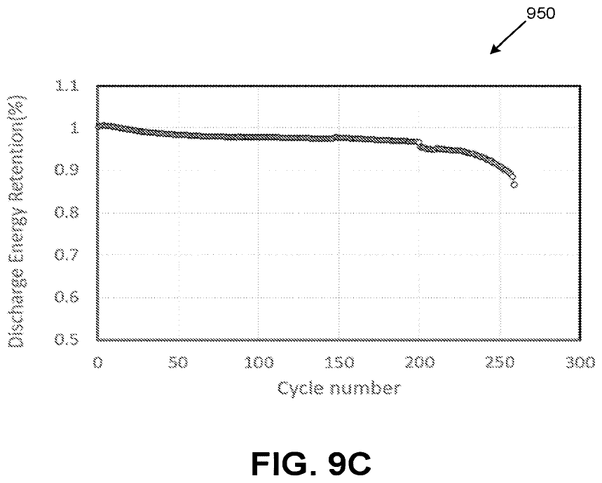

Sample Cell II may be tested for its capacity, direct current resistance (DCR), and cycle life before and after zero-voltage exposure (ZVE) in the same manner as Sample Cell I. Table 2 below depicts a comparative analysis of the capacity and direct current resistance (DCR) of Sample Cell II before and after zero-voltage exposure (ZVE). FIG. 9A depicts a graph 900 illustrating voltage, capacity, and direct current resistance (DCR) of Sample Cell II before and after zero-voltage exposure (ZVE). As shown in Table 2 and FIG. 9A, the capacity, voltage-time profile of Sample Cell II remained substantially the same before and after zero-voltage exposure (ZVE). The discharge capacity of Sample Cell II is 3.932 ampere-hours before zero-voltage exposure (ZVE) and 3.891 ampere hours after zero-voltage exposure, representative a loss of approximately ˜ 1.06%. Meanwhile, the direct current resistance (DCR) of Sample Cell II exhibited slight changes at 95%, 50%, and 20% state of charge (SOC).

TABLE 2

| Parameter | Before ZVE | After ZVE | Δ(%) |
|---|---|---|---|
| Charge Capacity (Ah) | 3.929 | 3.890 | −0.98 |
| Discharge Capacity (Ah) | 3.932 | 3.891 | −1.06 |
| Charge Energy (Wh) | 14.90 | 14.76 | −0.139 |
| Discharge Energy (Wh) | 13.54 | 13.43 | −0.87 |
| Coulombic Efficiency (%) | 100.08 | 100.00 | −0.79 |
| Energy Efficiency (%) | 90.91 | 90.97 | 0.065 |
| DCR_95% SOC (mΩ) | 33.70 | 34.18 | 1.448 |
| DCR_50% SOC (mΩ) | 30.53 | 31.795 | 4.143 |
| DCR_20% SOC (mΩ) | 38.66 | 38.889 | 0.59 |

FIG. 9B depicts a graph 925 illustrating a voltage-time profile of Sample Cell II while Sample Cell II is subjected to 7 days of zero-voltage exposure at 20 ohms. The discharge capacity of Sample Cell II is 3.967 ampere hours from 4.4 volts to 2.5 volts, 0.466 ampere hours from 2.5 volts to 0 volts, and 0.346 ampere hours at 0 volts. The deep discharge of Sample Cell II released 0.812 ampere hours, resulting in a total discharge capacity 4.779 ampere hours. The zero-voltage exposure (ZVE) therefore contributed a ˜20.46% change in the discharge capacity of Sample Cell II. FIG. 9C depicts a graph 950 illustrating the cycle life of Sample Cell II after Sample Cell II is subjected to 7 days of zero-voltage exposure (ZVE) at 20 ohms. As shown in DIG. 9C, the discharge energy retention of Sample Cell II is 86.3% after 260 cycles. Sample Cell II therefore exhibited an energy loss of 13.7%, which is almost 10 times of that present in Sample Cell I after 270 cycles. A comparison between Sample Cell I (with a zinc (Zn) foil sacrificial electrode) and Sample Cell II (without a sacrificial electrode) shows that the presence of a sacrificial metal foil preserved the capacity of Sample Cell I by protecting the negative current collector when Sample Cell I is over discharged to 0 volts.

### Sample Cell III

The positive electrode of Sample Cell III may be formed in the same manner as the positive electrode of Sample Cell II, which includes dissolving a certain quantity of polyvinylidene difluoride (PVDF) in N-methylpyrrolidone (NMP) to prepare an 8% polymer solution. A certain quantity of carbon black may be added to the 8% polymer solution and mixed for 30 minutes at 6500 revolutions-per-minute to form a slurry. A certain quantity of high nickel lithium nickel manganese cobalt oxide may be added the slurry and mixed for 30 minutes at 6500 revolutions-per-minute with additional N-methylpyrrolidone (NMP) added for adjusting the viscosity to achieve a flowable slurry. The flowable slurry may be coated onto an aluminum (Al) foil (e.g., 15-μm aluminum foil) using an automatic coating machine with the first heat zone set to approximately 80° C. and the second heat zone set to approximately 130° C. to evaporate the N-methylpyrrolidone (NMP). The positive electrode of Sample Cell III may then be formed by compressing the aluminum (Al) foil coated with the slurry to a target thickness and cutting to a target width (e.g., 56 millimeters). A positive tab may be welded to a mass free zone, for example, at the center of the positive electrode.

The negative electrode of Sample Cell III may be formed in the same manner as the negative electrode of Sample Cell II, which includes dissolving a certain quantity of binder in deionized water and then a conductive additive is added and mixed for 30 minutes at 6500 revolutions-per-minute. Silicon (Si)/silica oxide (SiO) and a carbon composite may be added to the resulting solution and mixed for 60 minutes at 6500 revolutions-per-minute. Additional water may be added to adjust the viscosity and form a flowable slurry. The slurry may then be coated on to a copper (Cu) foil (e.g., 9-μm thick copper foil) using an automatic coater. The negative electrode of Sample Cell III may be formed by compressing the copper (Cu) foil coated with the slurry to a target thickness and cutting to a target width (e.g., 58 millimeters).

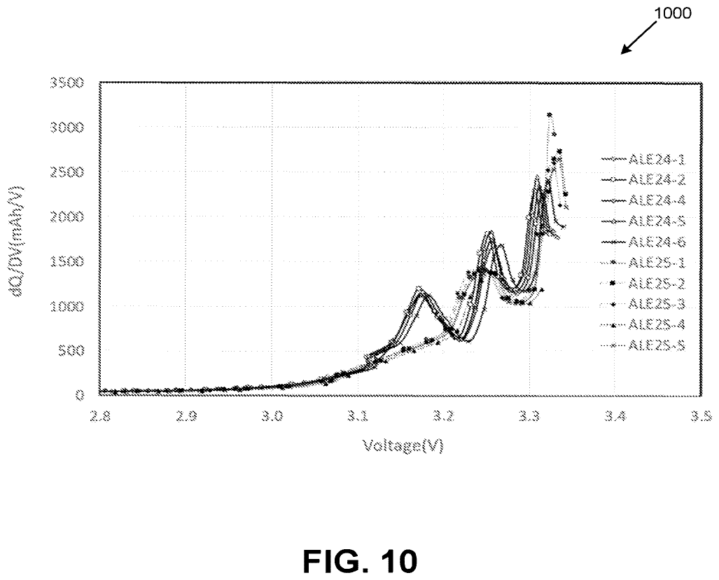

Sample Cell III may be assembled in the same manner as Sample Cell II. For example, the jellyroll of Sample Cell III may be formed by winding the positive electrode, the separator, and the negative electrode using, for example, a winding machine. The jellyroll may be inserted into a case which may be, for example, a metal case, a soft pouch, and/or the like. One of the negative tabs may be welded to the case while the positive tab may be welded to the header of Sample Cell III, for example, by laser welding. The unfinished Sample Cell III may be dried at 80° C. for at least 12 hours before the dried Sample Cell III is filled with electrolyte and crimped. Sample Cell III may be aged for 24 hours at room temperature and before undergoing a formation process. For example, the open circuit voltage (OCV) and impedance of Sample Cell III at 1 kilohertz (KHz) may be ˜1.1 volts and ˜23 milliohms respectively. Sample Cell III may be formed at 100 milliamps with 300 milliampere hours and charged to 4.2 volts before being aged for 7 days at room temperature. FIG. 10 depicts a graph 1000 illustrating a derivative analysis of capacity versus voltage. As shown in FIG. 10, Sample Cell III (e.g., ALE24-1, ALE24-2, ALE24-3, ALE24-5, and ALE24-6) exhibits three peaks at ˜3.172 volts, ˜3.256 volts, and 3.309 volts during its initial charge.

### Sample Cell IV

The positive electrode of Sample Cell IV may be formed in the same manner as the positive electrode of Sample Cell I, which includes dissolving a certain quality of polyvinylidene difluoride (PVDF) in N-methylpyrrolidone (NMP) to prepare an 8% polymer solution. A certain quantity of carbon black may be added to the 8% polymer solution and mixed for 30 minutes at 6500 revolutions-per-minute to form a slurry. A certain quantity of high nickel lithium nickel manganese cobalt oxide may be added the slurry and mixed for 30 minutes at 6500 revolutions-per-minute with additional N-methylpyrrolidone (NMP) added for adjusting the viscosity to achieve a flowable slurry. The flowable slurry may be coated onto an aluminum (Al) foil (e.g., 15-μm aluminum foil) using an automatic coating machine with the first heat zone set to approximately 80° C. and the second heat zone set to approximately 130° C. to evaporate the N-methylpyrrolidone (NMP). The positive electrode of Sample Cell IV may then be formed by compressing the aluminum (Al) foil coated with the slurry to a target thickness and cutting to a target width (e.g., 56 millimeters). A positive tab may be welded to a mass free zone, for example, at the center of the positive electrode.

The negative electrode of Sample Cell IV may be formed in the same manner as the negative electrode of Sample Cell I, which includes dissolving a certain quantity of binder in deionized water and then a conductive additive is added and mixed for 30 minutes at 6500 revolutions-per-minute. Silicon (Si)/silica oxide (SiO) and a carbon composite may be added to the resulting solution and mixed for 60 minutes at 6500 revolutions-per-minute. Additional water may be added to adjust the viscosity and form a flowable slurry. The slurry may then be coated on to a copper (Cu) foil (e.g., 9-μm thick copper foil) using an automatic coater. The negative electrode of Sample Cell IV may be formed by compressing the copper (Cu) foil coated with the slurry to a target thickness and cutting to a target width (e.g., 58 millimeters). A foil of pure zinc (Zn) corresponding to the sacrificial electrode may be welded (e.g., by ultrasonic welding) to the header or tail of the negative electrode depending on the desired configuration of Sample Cell VI. One or more negative tabs may be welded to the mass free zone of the negative electrode of Sample Cell VI.

Sample Cell IV may be assembled in the same manner as Sample Cell I. For example, the jellyroll of Sample Cell IV may be formed by winding the positive electrode, the separator, and the negative electrode using, for example, a winding machine. The jellyroll may be inserted into a case which may be, for example, a metal case, a soft pouch, and/or the like. One of the negative tabs may be welded to the case while the positive tab may be welded to the header of Sample Cell IV, for example, by laser welding. The unfinished Sample Cell IV may be dried at 80° C. for at least 12 hours before the dried Sample Cell IV is filled with electrolyte and crimped. Sample Cell IV may be aged for 24 hours at room temperature and before undergoing a formation process. Referring again to FIG. 10, which depicts a derivative analysis of capacity versus voltage, Sample Cell IV (e.g., ALE25-1, ALE25-2, ALE25-3, and ALE25-5) exhibited two peaks at ˜3.240 volts and ˜3.323 volts whereas Sample Cell III exhibits three peaks. The fewer voltage peaks exhibited by Sample Cell IV may be attributable to the presence of the pure zinc (Zn) sacrificial electrode.

### Sample Cell V

The positive electrode of Sample Cell V may be formed by dissolving a certain quantity of polyvinylidene difluoride (PVDF) in N-methylpyrrolidone (NMP) to prepare an 8% polymer solution. A certain quantity of carbon black may be added to the 8% polymer solution and mixed for 30 minutes at 6500 revolutions-per-minute to form a slurry. A certain quantity of high nickel lithium nickel manganese cobalt oxide may be added the slurry and mixed for 30 minutes at 6500 revolutions-per-minute with additional N-methylpyrrolidone (NMP) added for adjusting the viscosity to achieve a flowable slurry. The flowable slurry may be coated onto an aluminum (Al) foil (e.g., 15-μm aluminum foil) using an automatic coating machine with the first heat zone set to approximately 80° C. and the second heat zone set to approximately 130° C. to evaporate the N-methylpyrrolidone (NMP). The positive electrode of Sample Cell V may then be formed by compressing the aluminum (Al) foil coated with the slurry to a target thickness and cutting to a target width (e.g., 56 millimeters). A positive tab may be welded to a mass free zone, for example, at the center of the positive electrode.

The negative electrode of Sample Cell V may be formed by incorporating a first material having a lower decomposition voltage than a second material of the negative current collector directly into a third material of the negative electrode. The negative electrode of Sample Cell V may be formed by dissolving a certain quantity of binder in deionized water and then a conductive additive is added and mixed for 30 minutes at 6500 revolutions-per-minute. A small amount of Zinc (Zn) powder (e.g., between 1 micrometer and 5 micrometers) (2% in weight in total solid of the negative electrode) may be added to the resulting slurry and mixed at 3000 revolutions-per-minute. Silica (Si)/silica oxide (SiO) and a carbon composite may be added to the zinc (Zn) slurry and mixed for 60 minutes at 6500 revolutions-per-minute to form a flowable slurry with water being added to adjust the viscosity necessary to achieve a smooth coating. The resulting slurry may be coated onto a copper (Cu) foil (e.g., 8-μm thick Cu foil) using an automatic coater. The negative electrode of Sample Cell V may be compressed to a desired thickness and sliced to a target width (e.g., 58 millimeters). One or more negative tabs may be welded to the mass free zone of the negative electrode of Sample Cell V.

The assembly of Sample Cell V includes forming a jellyroll by winding the positive electrode, the separator, and the negative electrode using, for example, a winding machine. The jellyroll may be inserted into a case which may be, for example, a metal case, a soft pouch, and/or the like. One of the negative tabs may be welded to the case while the positive tab may be welded to the header of Sample Cell V, for example, by laser welding. The unfinished Sample Cell V may be dried at 80° C. for at least 12 hours before the dried Sample Cell V is filled with electrolyte and crimped. Sample Cell V may be aged for 24 hours at room temperature and before undergoing a formation process. For example, the open circuit voltage (OCV) and impedance of Sample Cell V at 1 KHz may be approximately 0.765 volts and 19 milliohms. Sample Cell V may be formed at C/40 with 300 milliampere hours before being aged for 7 days at room temperature.

### Sample Cell VI

The positive electrode of Sample Cell VI may incorporate manganese di-oxide (MnO₂) to provide additional protection against the decomposition of the negative current collector when Sample Cell VI undergoes zero-voltage exposure. The positive electrode of Sample Cell VI may be formed by mixing 200 grams of lithium cobalt oxide (LiCoO₂) active and 3 grams of JD-600 carbon black into 100 grams of a polyvinylidene difluoride (PVDF) and N-methylpyrrolidone (NMP) binder solution (e.g., an 8% PVDF NMP solution). Manganese di-oxide (MnO₂) powder (e.g., 2 grams of MnO₂ power) may be added to the resulting slurry and mixed for 30 minutes at 4000 revolutions-per-minute. The viscosity of the slurry may be adjusted by the addition of N-methylpyrrolidone (NMP) before being coated onto an aluminum foil (e.g., 16-μm thick aluminum foil) with a loading of 21 mg/cm². The solvent may be evaporated using a reverse roll coater before the positive electrode is calendered to a target thickness (e.g., 138 μm) and sliced to desired dimensions (e.g., 56 millimeters wide and 700 millimeters long). A positive tab (e.g., an aluminum (Al) tab) may be welded to a mass free zone, for example, at the center of the positive electrode using an ultrasonic welder.

The negative electrode of Sample Cell VI may be formed by incorporating a first material having a lower decomposition voltage than a second material of the negative current collector directly into a third material of the negative electrode. The negative electrode of Sample Cell VI may be formed by mixing 200 grams of graphite negative active and 3 grams of carbon black into 150 grams of a carboxymethyl cellulose (CMC) water binder solution (e.g., a 1.5% CMC water solution) and then 50 grams of water and 2 grams of zinc (Zn) powder are added and mixed for 30 minutes at 4000 revolutions-per-minute. A suspension solution (e.g., 8 grams of a styrene-butadiene-rubber (SBR) suspension solution with a 48% solid content) may be added to the slurry with the viscosity adjusted by the addition of water if needed. The resulting slurry may be coated onto a copper (Cu) foil (e.g., 8-μm thick copper foil) with a loading of 10 mg/cm² before being dried using a reverse roll coater to remove the solvent. The negative electrode may be calendered to a target thickness (e.g., 148 μm) and sliced to desired dimensions (e.g., 58 millimeters wide and 650 millimeters long). One or more negative tabs (e.g., one or more nickel (Ni) tabs) may be welded to a mass free zone of the negative electrode.

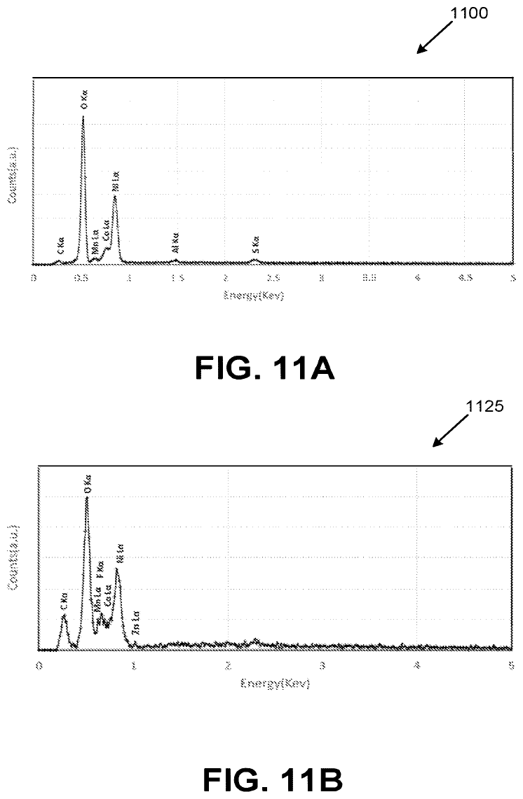

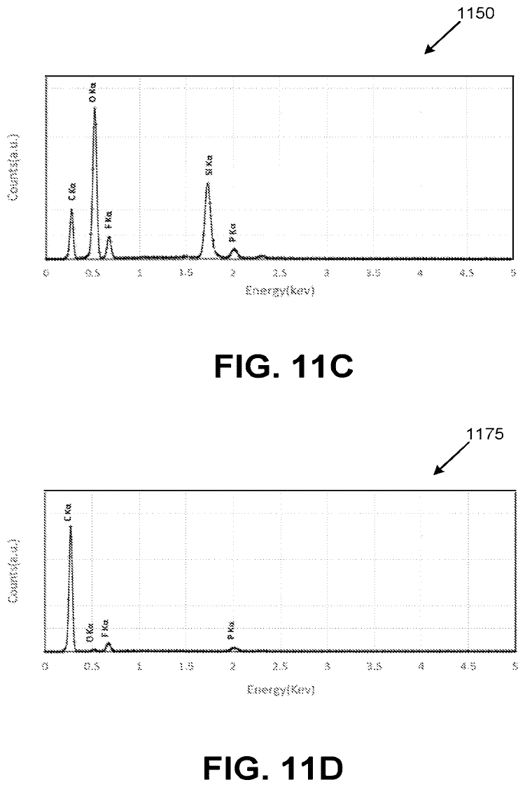

The assembly of Sample Cell VI includes forming a jellyroll by winding the positive electrode, the separator, and the negative electrode using, for example, a winding machine. The jellyroll may be inserted into a case which may be, for example, a metal case, a soft pouch, and/or the like. One of the negative tabs may be welded to the case while the positive tab may be welded to the header of Sample Cell VI, for example, by laser welding. The unfinished Sample Cell VI may be dried at 80° C. for at least 48 hours before the dried Sample Cell VI is filled with 5.5 grams of electrolyte and crimped. Sample Cell VI may be aged for 24 hours at room temperature and before undergoing a formation process that includes charging Sample Cell VI at C/50 to 4.2 volts, resting for 10 minutes, and discharging Sample Cell VI at C/5 to 3 volts. A scanning electron microscopy (SEM) analysis of the separator, the positive electrode, and the negative electrode of a battery cell may be performed to demonstrate that a sacrificial electrode preserves the negative current collector of the battery cell from anodic corrosion when the battery cell is discharged to a low-voltage state or a zero-voltage state. Table 3 and graph 1100 depicted in FIG. 11A illustrate the elemental composition of the high nickel lithium nickel manganese cobalt oxide powder used to form the positive electrode of the battery cell. As shown in Table 3 and graph 1100, the high nickel lithium nickel manganese cobalt oxide powder used to form the positive electrode of the battery cell does not contain zinc (Zn) or copper (Cu).

TABLE 3

| | | Weight (%) | | Atom (%) |
|---|---|---|---|---|
| Element | Weight (%) | Error | Atom (%) | Error |
| C | 0.83 | ±0.06 | 2.38 | ±0.17 |
| O | 24.62 | ±0.21 | 52.84 | ±0.44 |
| Ni | 57.44 | ±1.47 | 33.60 | ±0.86 |
| Mn | 8.03 | ±0.48 | 5.02 | ±0.30 |
| Co | 7.62 | ±0.77 | 4.44 | ±0.45 |
| Al | 0.78 | ±0.04 | 0.99 | ±0.05 |
| S | 0.67 | ±0.07 | 0.72 | ±0.08 |

Table 4 and graph 1125 depicted in FIG. 11B illustrate the elemental composition of a positive electrode collected from a battery cell after the battery cell is subjected to zero voltage exposure (ZVE) and cycling. As shown in Table 4 and graph 1125, approximately 1.85% by weight of zinc (Zn) was detected in the positive electrode of the battery cell but no trace of copper (Cu) was found. The presence of zinc (Zn) and the absence of copper (Cu) indicate that the zinc (Zn) sacrificial electrode has decomposed to protect the copper (Cu) current collector from anodic corrosion.

TABLE 4

| | | Weight (%) | | Atom (%) |
|---|---|---|---|---|
| Element | Weight (%) | Error | Atom (%) | Error |
| C | 7.19 | ±0.29 | 16.81 | ±0.67 |
| O | 27.96 | ±0.50 | 46.42 | ±0.87 |
| F | 5.59 | ±0.82 | 8.27 | ±1.21 |
| Ni | 45.03 | ±0.29 | 21.56 | ±1.62 |
| Mn | 7.15 | ±1.11 | 3.66 | ±0.57 |
| Co | 5.23 | ±0.94 | 2.49 | ±0.45 |
| Zn | 1.85 | ±0.54 | 0.79 | ±0.23 |

Table 5 and graph 1150 depicted in FIG. 11C illustrate the elemental composition of the negative electrode collected from the battery cell after the battery cell is subjected to zero-voltage exposure (ZVE) and cycling. Table 5 and graph 1150 show that no quantities of nickel (Ni), manganese (Mn), cobalt (Co), or zinc (Zn) were detected at the negative electrode of the battery cell after zero-voltage exposure. These results indicate that zinc (Zn) at the positive electrode does not dissolve significantly into the electrolyte and therefore causes no reduction on the surface of the negative electrode. The zinc (Zn) sacrificial electrode protects the copper (Cu) negative current collector from anodic corrosion but was not itself reduced on the surface of the negative electrode. Thus, the dissolution of the zinc (Zn) sacrificial electrode poses no safety concerns at least because the dissolved zinc (Zn) does not form dendrites on the surface of the negative electrode like lithium (Li) or Copper (Cu).

TABLE 5

| | | Weight (%) | | Atom (%) |
|---|---|---|---|---|
| Element | Weight (%) | Error | Atom (%) | Error |
| C | 17.36 | ±0.13 | 24.34 | ±0.19 |
| O | 48.60 | ±0.32 | 51.01 | ±0.34 |
| F | 15.39 | ±0.25 | 13.64 | ±0.23 |
| Si | 15.72 | ±0.10 | 9.43 | ±0.04 |
| P | 2.93 | ±0.06 | 1.58 | ±0.02 |
| Zn | 0 | 0 | 0 | 0 |

Table 6 and graph 1175 depicted in FIG. 11D illustrate the elemental composition of the separator collected from the battery cell after the battery cell is subjected to zero-voltage exposure and cycling. As shown in Table 6 and graph 1175, no amounts of nickel (Ni), manganese (Mn), cobalt (Co), and Zinc (Zn) were detected in the separator. The zinc (Zn) that is present at the positive electrode does not dissolve into the electrolyte and is therefore not transported through the pores of the separator. Thus, the dissolution of the zinc (Zn) sacrificial electrode poses no safety concerns at least because the dissolved zinc (Zn) does not form dendrites on the surface of the negative electrode like lithium (Li) or Copper (Cu).

TABLE 6

| | | Weight (%) | | Atom (%) |
|---|---|---|---|---|
| Element | Weight (%) | Error | Atom (%) | Error |
| C | 74.22 | ±0.35 | 81.85 | ±0.39 |
| O | 4.17 | ±0.21 | 3.54 | ±0.18 |
| F | 18.21 | ±0.17 | 13.01 | ±0.12 |
| P | 3.40 | ±0.07 | 1.6 | ±0.02 |
| Zn | 0 | 0 | 0 | 0 |

### Sample Cell VII

Commercial 3.5Ah 18650 cells were tested according to the same testing sequence for zero-voltage exposure (ZVE) in Sample Cells I and II.

The cycle life at 100% depth of discharge (DOD) for Sample Cell VII may be determined by the first resting for 2 hours. Sample Cell VII may be charged at a constant current and constant voltage (CC-CV) at C/3 to 4.2 volts until <C/20, rested for 10 minutes, discharged at a constant current (CCD) at C/5 to 2.5 volts, and rested for 30 minutes. Sample Cell VII may be repeated charged and discharged until ˜80% capacity retention.

The response of Sample Cell VII to zero-voltage exposure (ZVE) may be determined by measuring the initial 20° C. capacity and direct current resistance (DCR) of Sample Cell VII. Sample Cell VII may then be discharged at a constant current and constant voltage (CC-CV) at C/5 to 4.2 volts until <C/20, rested for 10 minutes, discharged at a constant current (CCD) at C/5 to 2.5 volts, rested for 30 minutes, discharged at a constant current (CCD) at C/5 to 0 volts, and further discharged 20 ohms while at 0 volts for 7 days. Thereafter, Sample Cell VII may be charged at a constant current and constant voltage (CC-CV) to 3.8 volts at C/5 before being rested for 24 hours. The 20° C. capacity and direct current resistance (DCR) of Sample Cell VII may be determined at this point.

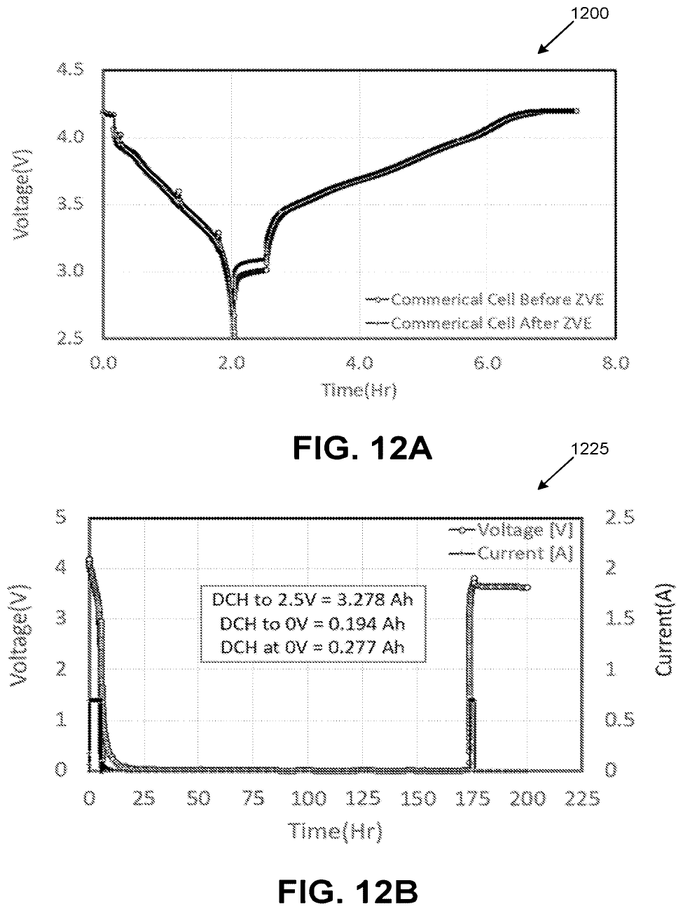

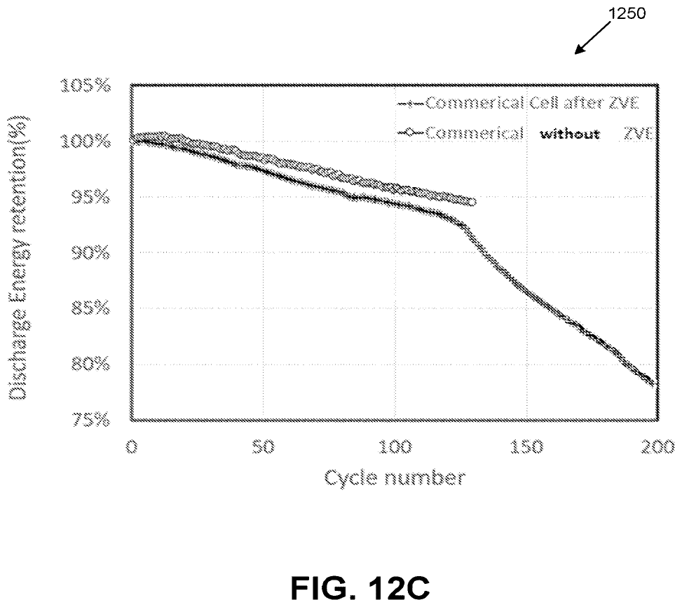

Table 7 below depicts a comparative analysis of the capacity and direct current resistance (DCR) of Sample Cell VII before and after zero-voltage exposure (ZVE). FIG. 12A depicts a graph 1200 illustrating voltage, capacity, and direct current resistance (DCR) of Sample Cell VII before and after zero-voltage exposure (ZVE). As shown in Table 7 and graph 1200 of FIG. 12A, the capacity-time profile of Sample Cell VII is substantially the same before and after zero-voltage exposure (ZVE). The discharge capacity of Sample Cell VII is 3.24 ampere hours before zero-voltage exposure (ZVE) and 3.16 ampere hours after zero-voltage exposure (ZVE), representative of a loss of ˜ 2.46%. The direct current resistance (DCR) at 95%, 50%, and 20% state of charge also exhibits ˜10% change after zero-voltage exposure (ZVE).

TABLE 7

| Parameter | Before ZVE | After ZVE | Δ(%) |
|---|---|---|---|
| Charge capacity/Ah | 3.237 | 3.180 | −1.77 |
| Discharge capacity/Ah | 3.24 | 3.16 | −2.46 |
| Charge energy/Wh | 12.39 | 12.21 | −1.44 |
| Discharge energy/Wh | 11.43 | 11.08 | −3.11 |
| C.E./% | 100.01 | 99.34 | −0.66 |
| E.E./% | 92.26 | 90.69 | −1.69 |
| DCR_95%/mΩ | 65.81 | 74.9 | 13.80 |
| DCR_50%/mΩ | 61.71 | 69.14 | 12.03 |
| DCR_20%/mΩ | 70.85 | 75.71 | 6.84 |

FIG. 12B depicts a graph 1225 illustrating a voltage-time profile of Sample Cell VII while Sample Cell VII is subjected to 7 days of zero-voltage exposure (ZVE) at 20 ohms. The discharge capacity of Sample Cell VII is 3.278 ampere hours from 4.2 volts to 2.5 volts, 0.194 ampere hours from 2.5 volts to 0 volts, and 0.277 ampere hours at 0 volts. The deep discharge of Sample Cell VII released 0.471 ampere hours, resulting in a total discharge capacity of 3.749 ampere hours. The zero-voltage exposure (ZVE) therefore contributed a ˜14.36% change in the discharge capacity of Sample Cell VII. FIG. 12C depicts a graph 1250 illustrating the cycle life of Sample Cell VII after Sample Cell VII is subjected to zero-voltage exposure (ZVE) for 7 days at 20 ohms. As shown in FIG. 12C, the discharge energy retention of Sample Cell VII is ˜91% after 130 cycles and only ˜78% after 200 cycles. Moreover, Sample Cell VII without zero voltage exposure as the reference exhibits a capacity loss of ˜94.5% after cycling after 130 cycles. The zero-voltage exposure (ZVE) really causes significant damage to the cycle life of the commercial 18650 cells.

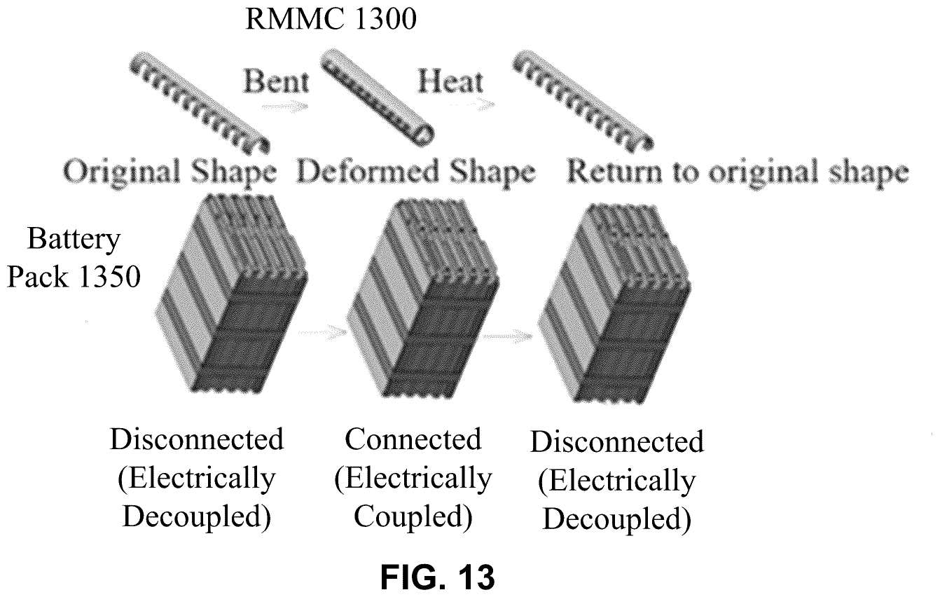

In some implementations of the current subject matter, a battery pack may include two or more metal ion battery cells, such as the battery cell 100, connected by one or more reversible memory metal-based connectors (RMMCs). FIG. 13 depicts an example of a reversible memory metal-based connector (RMMC) 1300, in accordance with some example embodiments. Referring to FIG. 13, the reversible memory metal-based connector 1300 may connect the battery cells (e.g., metal ion battery cells) in a battery pack 1350. For example, in some cases, the reversible memory metal-based connector 1300 may include prongs (or teeth) that are inserted through apertures in the electrode tabs of each metal ion battery cell in the battery pack 1350. As shown in FIG. 13, the reversible memory metal-based connector 1300 may be transitioned between an original (or undeformed) state and a deformed state, for example, by the application of heat. In the original (or undeformed) state, the reversible memory metal-based connector 1300 may be at least partially detached (or disconnected) from the electrode tabs of each metal ion battery cell in the battery cell 1350. As a result, the two or more battery cells in the battery pack 135 may be disconnected (or electrically decoupled) from one another while the reversible memory metal-based connector 1300 is in its original (or undeformed state). Contrastingly, FIG. 13 shows that the reversible memory metal-based connector 1300 may be transitioned to a deformed state, for example, by the application of force to at least partially deform the reversible memory metal-based connector 1300. In its deformed state, the reversible memory metal-based connector 1300 may provide an electrical connection between the two or more battery cells (e.g., metal ion battery cells) in the battery pack 1350 such that an electrical current may flow therebetween. As further shown in FIG. 13, the application of heat may cause the reversible memory metal-based connector 1300 to revert back to its original (or undeformed state). As noted, while the reversible memory metal-based connector 1300 is in its original (or undeformed state), the reversible memory metal-based connector 1300 may be partially detached from the battery cells in the battery pack 1350 such that electrical current is unable to flow therebetween.

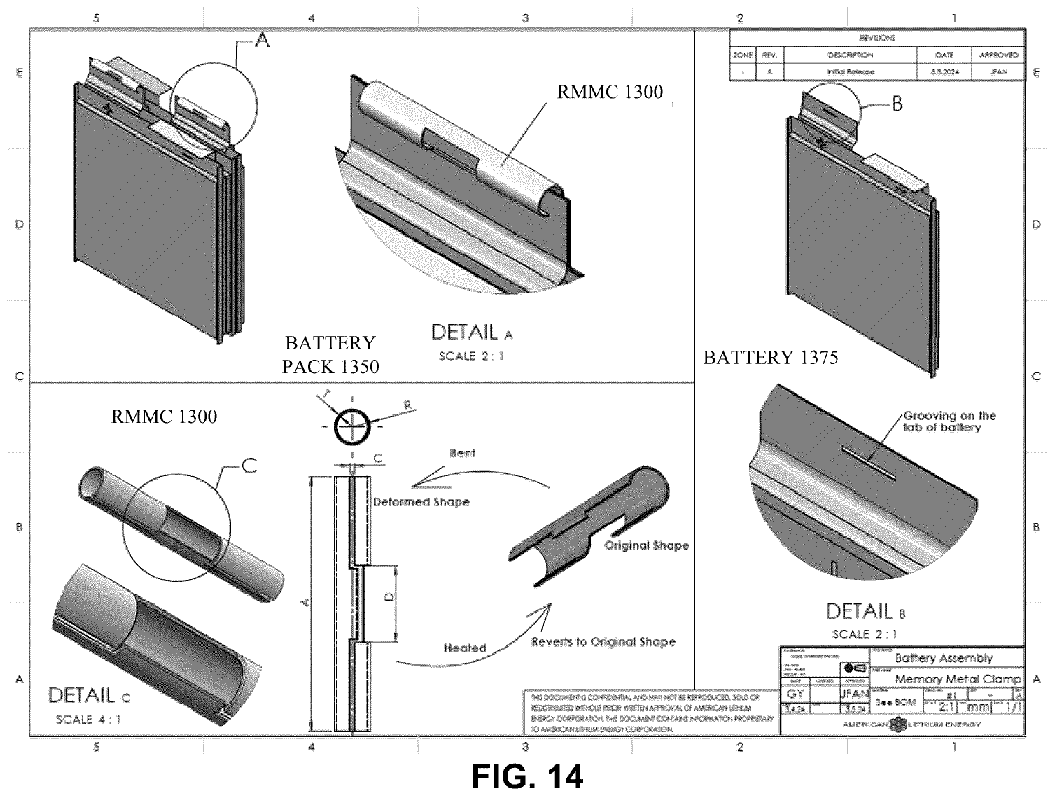

FIG. 14 depicts an example of the reversible memory metal-based connector 1300, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. As shown in FIG. 14, in some cases, the electrode tab of the battery cell 1375 may include a groove (or another type of aperture) to accommodate at least a portion of the reversible memory metal-based connector 1300 that extends through the groove. As further shown in FIG. 14, in some cases, the reversible memory metal-based connector 1300 may be a clamp that is in a closed state while the reversible memory metal-based connector 1300 is in the deformed state and an open state while the reversible memory metal-based connector 1300 is in the original (or undeformed) state.

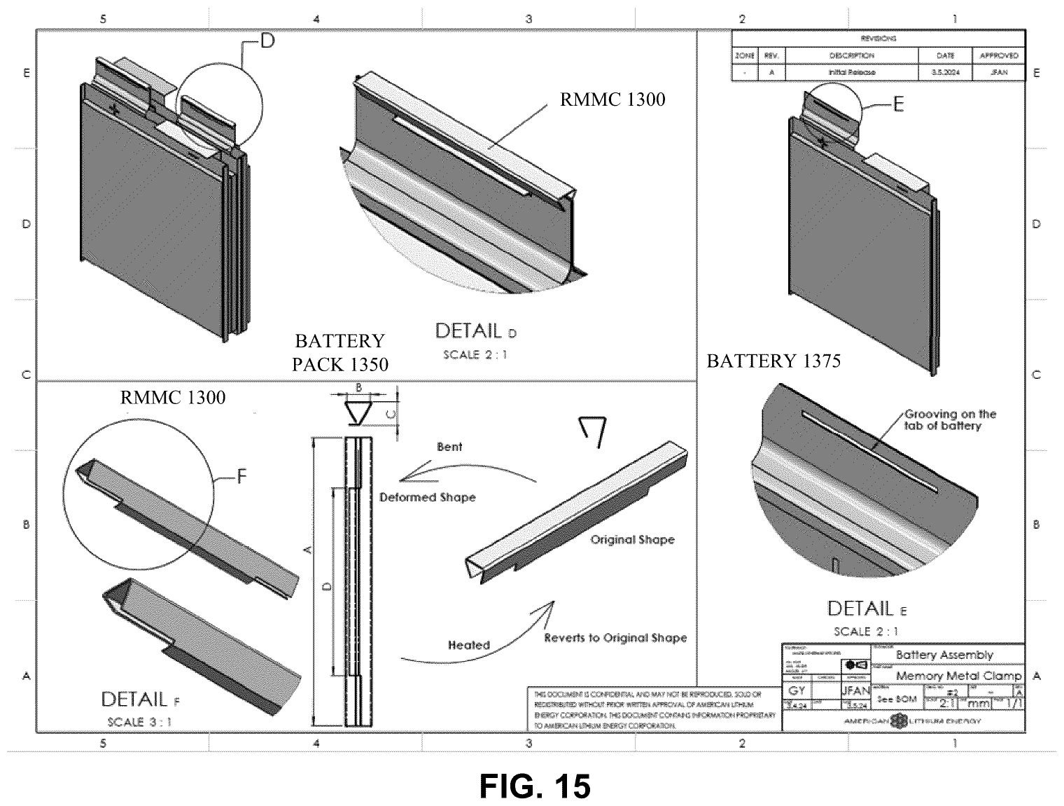

FIG. 15 depicts another example of a reversible memory metal-based connector, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. As shown in FIG. 15, in some cases, the electrode tab of the battery cell 1375 may include a groove (or another type of aperture) to accommodate at least a portion of the reversible memory metal-based connector 1300 that extends through the groove. As further shown in FIG. 15, in some cases, the reversible memory metal-based connector 1300 may be a clamp that is in a closed state while the reversible memory metal-based connector 1300 is in the deformed state and an open state while the reversible memory metal-based connector 1300 is in the original (or undeformed) state.

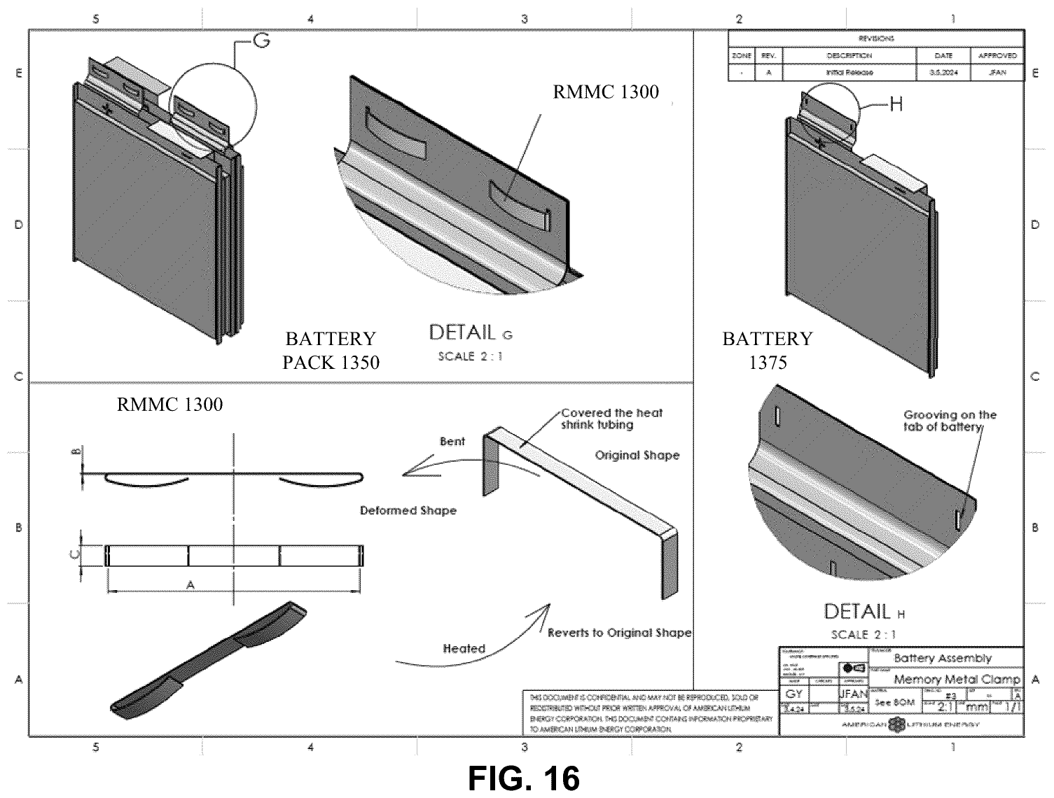

FIG. 16 depicts another example of a reversible memory metal-based connector, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. As shown in FIG. 16, in some cases, the electrode tab of the battery cell 1375 may include two grooves (or another type of aperture) such that the reversible memory metal-based connector 1300 may be threaded through the apertures before being bent to be secured to the electrode tab of the battery cell 1375. As further shown in FIG. 16, in some cases, the reversible memory metal-based connector 1300 may be a clamp that is in a closed state while the reversible memory metal-based connector 1300 is in the deformed state and an open state while the reversible memory metal-based connector 1300 is in the original (or undeformed) state.

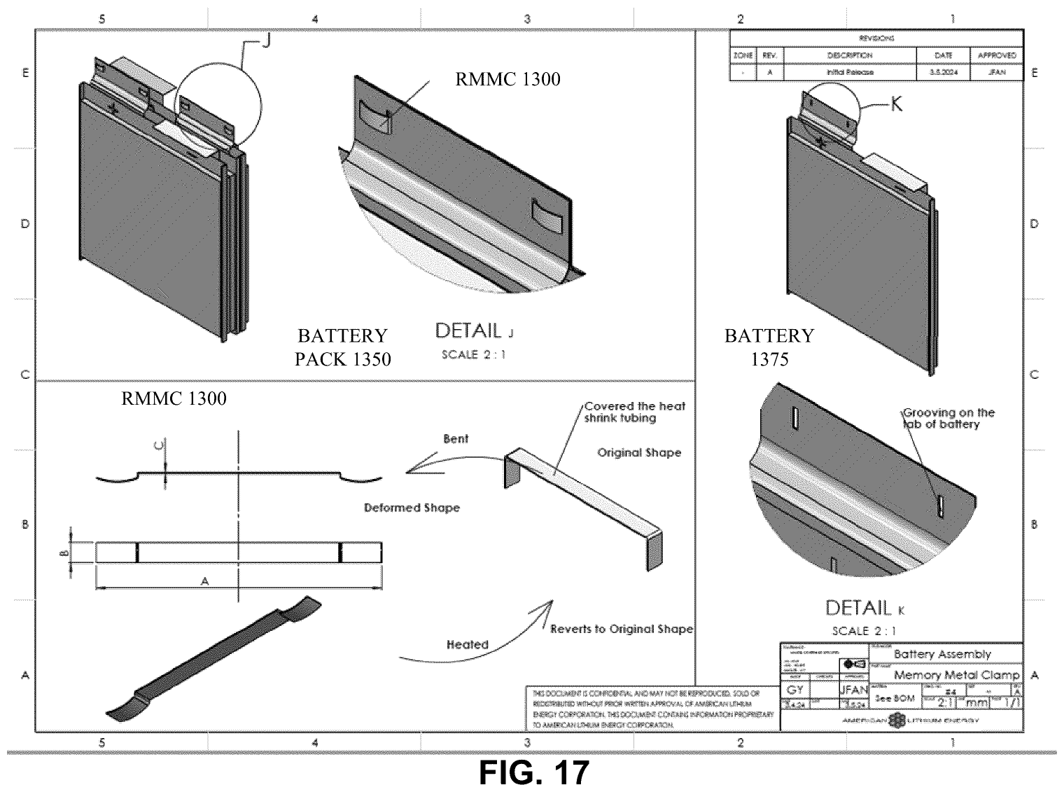

FIG. 17 depicts another example of a reversible memory metal-based connector, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. As shown in FIG. 16, in some cases, the electrode tab of the battery cell 1375 may include two grooves (or another type of aperture) such that the reversible memory metal-based connector 1300 may be threaded through the apertures before being bent to be secured to the electrode tab of the battery cell 1375. The example of the reversible memory metal-based connector 1300 shown in FIG. 17 is bent in an opposite direction as the example of the reversible memory metal-based connector 1300 shown in FIG. 16. As further shown in FIG. 17, in some cases, the reversible memory metal-based connector 1300 may be a clamp that is in a closed state while the reversible memory metal-based connector 1300 is in the deformed state and an open state while the reversible memory metal-based connector 1300 is in the original (or undeformed) state.

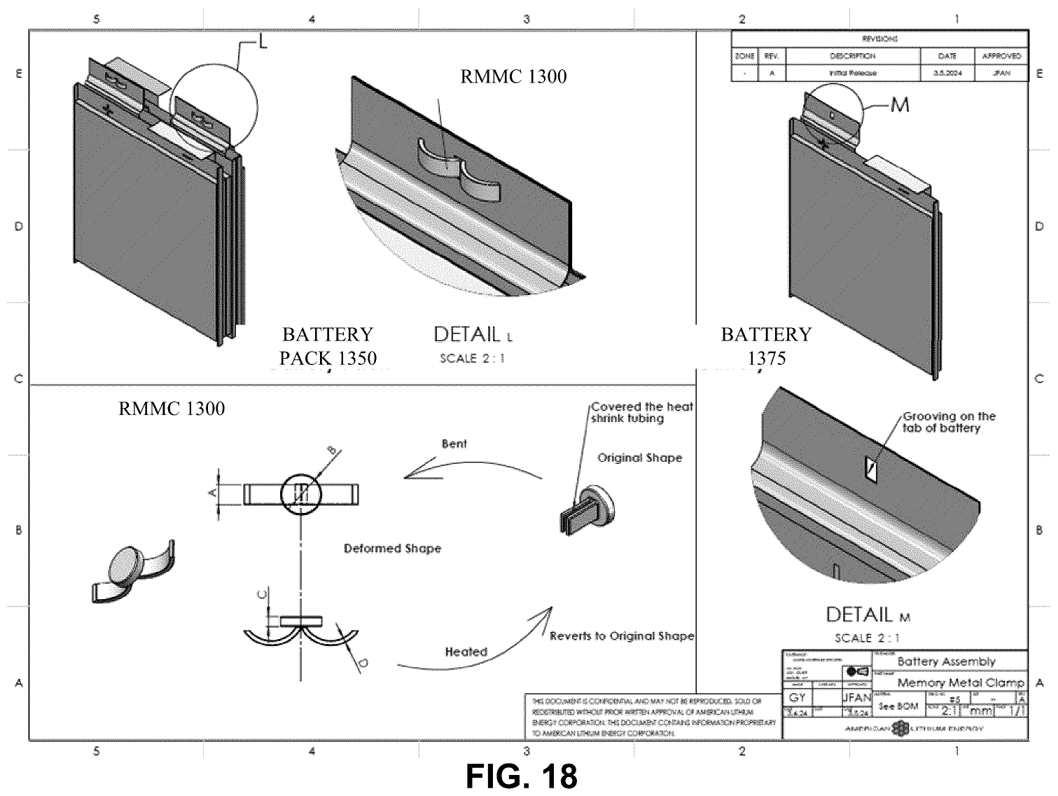

FIG. 18 depicts another example of a reversible memory metal-based connector, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. The two ends of the example of the reversible memory metal-based connector 1300 shown in FIG. 18 may be bent in opposite directions about a pivot point. In some cases, the reversible memory metal-based connector 1300 may include two pieces of reversible memory metal connected via a connector that is configured to remain on one side of the electrode tab of the battery cell 1375 while the two pieces of reversible memory metal are threaded through the groove (or another type of aperture) in the electrode tab of the battery cell 1375. As shown in FIG. 18, in some cases, the electrode tab of the battery cell 1375 may include a groove (or another type of aperture) such that the reversible memory metal-based connector 1300 may be threaded through the apertures before being bent to be secured to the electrode tab of the battery cell 1375. As further shown in FIG. 18, in some cases, the reversible memory metal-based connector 1300 may be a clamp that is in a closed state while the reversible memory metal-based connector 1300 is in the deformed state and an open state while the reversible memory metal-based connector 1300 is in the original (or undeformed) state.

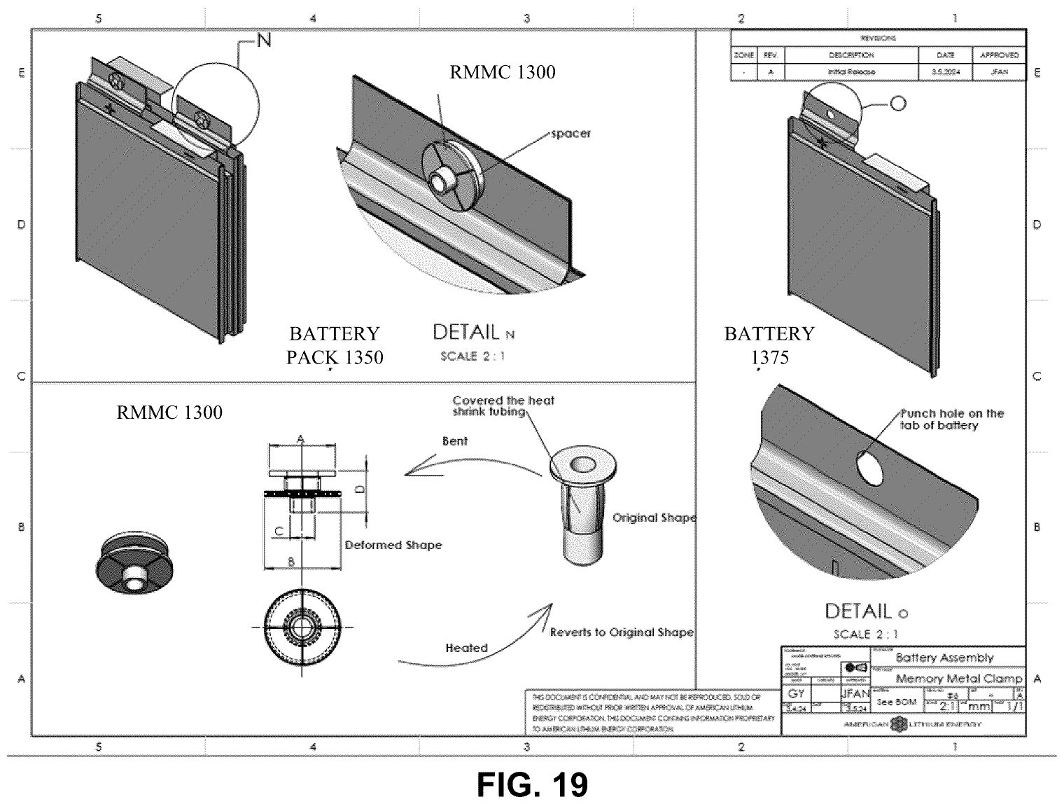

FIG. 19 depicts another example of a reversible memory metal-based connector, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. As shown in FIG. 19, in some cases, the electrode tab of the battery cell 1375 may include a punch hole (or another type of aperture) such that the reversible memory metal-based connector 1300 may be threaded through the aperture before being contracted (or compressed) to be secured to the electrode tab of the battery cell 1375. As further shown in FIG. 19, in some cases, the reversible memory metal-based connector 1300 may be a clamp that is in a closed (or contracted or compressed) state while the reversible memory metal-based connector 1300 is in the deformed state and an open state (or uncontracted or uncompressed) while the reversible memory metal-based connector 1300 is in the original (or undeformed) state.

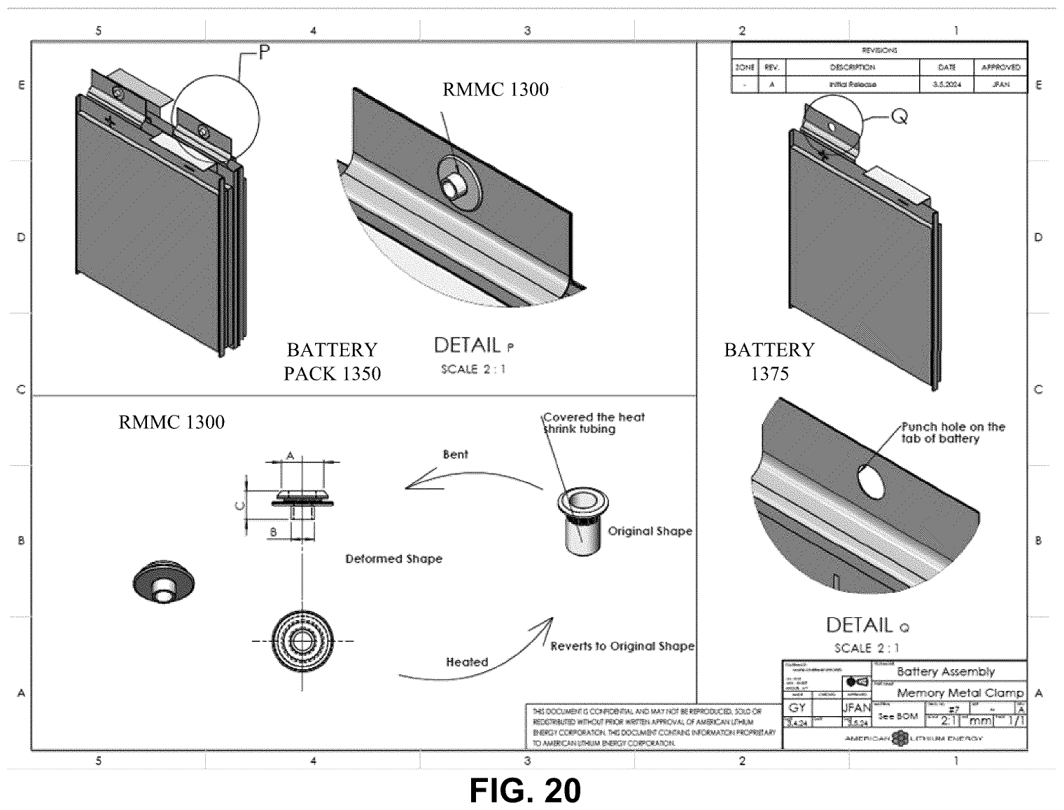

FIG. 20 depicts another example of a reversible memory metal-based connector, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. As shown in FIG. 20, in some cases, the electrode tab of the battery cell 1375 may include a punch hole (or another type of aperture) such that the reversible memory metal-based connector 1300 may be threaded through the aperture before being contracted (or compressed) to be secured to the electrode tab of the battery cell 1375. As further shown in FIG. 20, in some cases, the reversible memory metal-based connector 1300 may be a clamp that is in a closed (or contracted or compressed) state while the reversible memory metal-based connector 1300 is in the deformed state and an open state (or uncontracted or uncompressed) while the reversible memory metal-based connector 1300 is in the original (or undeformed) state.

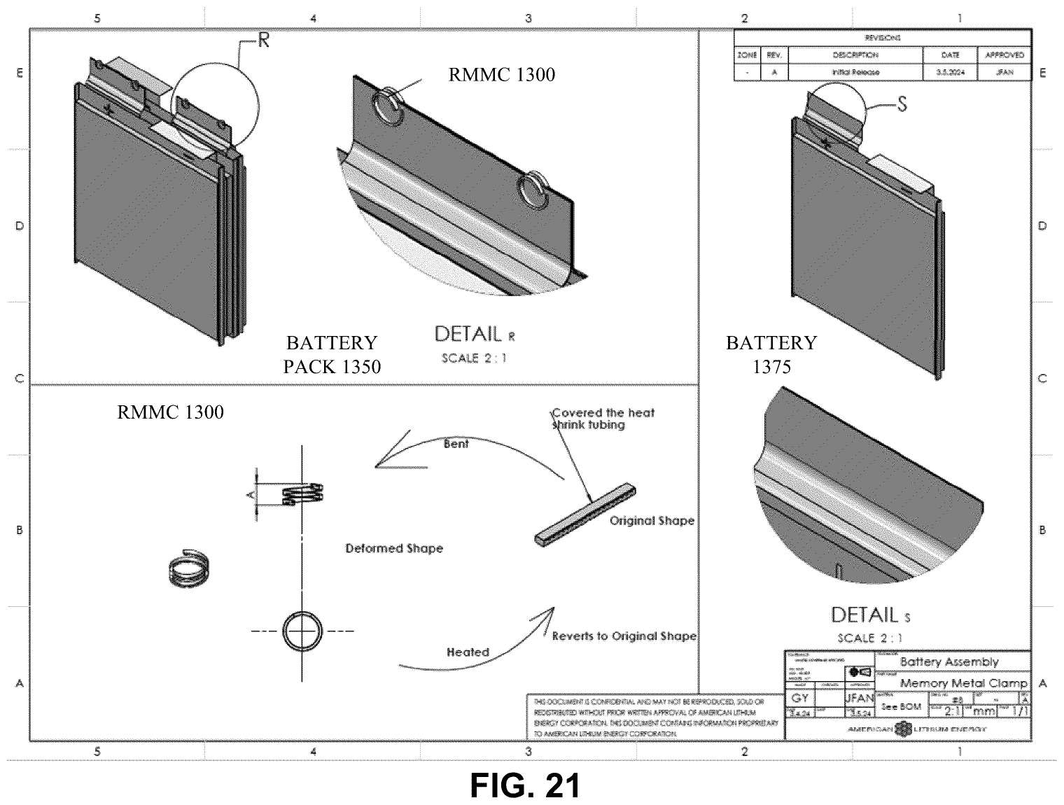

FIG. 21 depicts another example of a reversible memory metal-based connector, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. As shown in FIG. 21, in some cases, the reversible memory metal-based connector 1300 may be a clamp that is coiled while the reversible memory metal-based connector 1300 is in the deformed state. As such, while in the deformed state, the coils of the reversible memory metal-based connector 1300 may enable the reversible memory metal-based connector 1300 to be secured to the electrode tab of the battery cell 1375. It should be appreciated that the reversible metal-based connector 1300 may be coiled into a variety of different configurations, including the circular (or round) configuration shown in FIG. 21. As further shown in FIG. 21, in some cases, the reversible memory metal-based connector 1300 may be a clamp that is in a closed (or coiled) state while the reversible memory metal-based connector 1300 is in the deformed state and an open state (or uncoiled) while the reversible memory metal-based connector 1300 is in the original (or undeformed) state.

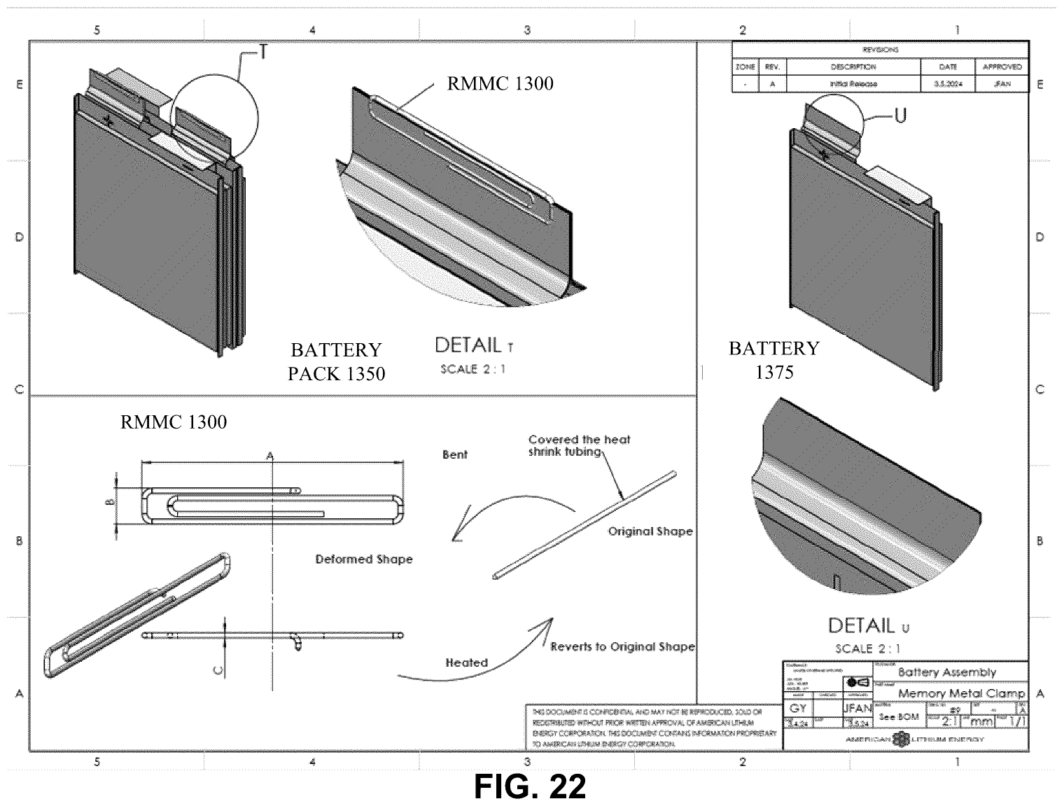

FIG. 22 depicts another example of a reversible memory metal-based connector, in accordance with some example embodiments. In some cases, the reversible memory metal-based connector 1300 may be a clamp that is secured to the electrode tab of each battery cell, such as the battery cell 1375, in the battery pack 1350 when the reversible memory metal-based connector 1300 is in the deformed state. As shown in FIG. 22, in some cases, the reversible memory metal-based connector 1300 may be a clamp that is coiled while the reversible memory metal-based connector 1300 is in the deformed state. As such, while in the deformed state, the coils of the reversible memory metal-based connector 1300 may enable the reversible memory metal-based connector 1300 to be secured to the electrode tab of the battery cell 1375. It should be appreciated that the reversible metal-based connector 1300 may be coiled into a variety of different configurations, including the paperclip-like configuration shown in FIG. 22. As further shown in FIG. 22, in some cases, the reversible memory metal-based connector 1300 may be a clamp that is in a closed (or coiled) state while the reversible memory metal-based connector 1300 is in the deformed state and an open state (or uncoiled) while the reversible memory metal-based connector 1300 is in the original (or undeformed) state.

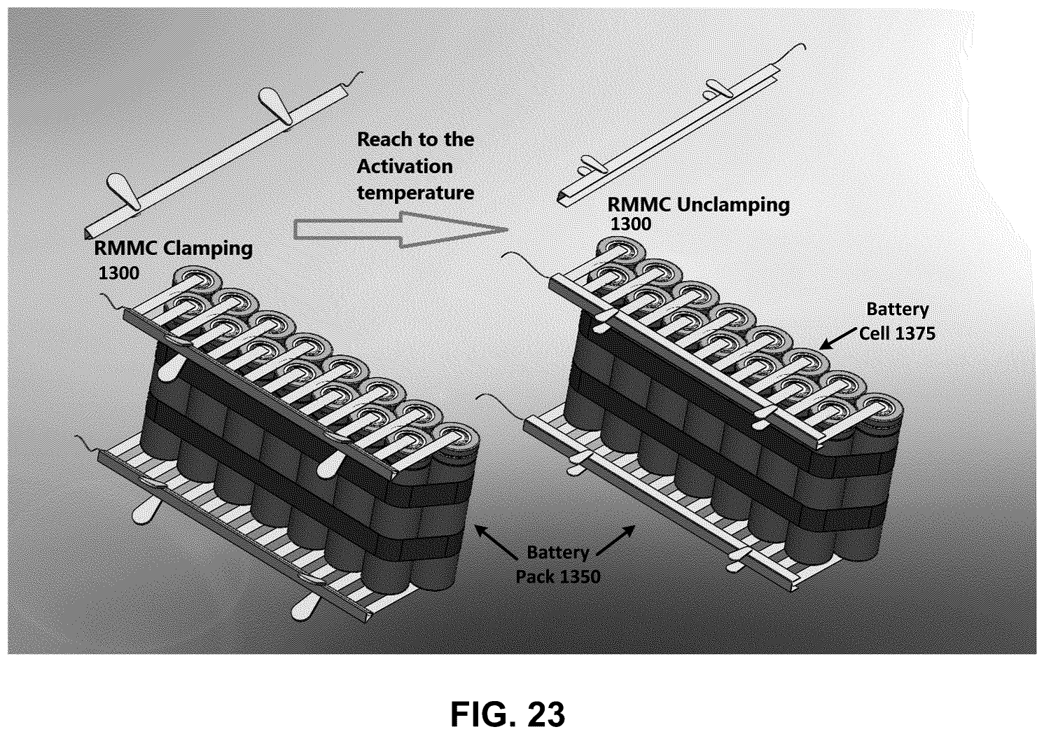

FIG. 23 depicts a perspective view of the battery pack 1350 including another example of the reversible memory metal-based connector (RMMC) 1300, in accordance with some example embodiments. The example of the reversible memory metal-based connector (RMMC) 1300 shown in FIG. 23 is a clamp that is in an open state when the reversible memory metal-based connector (RMMC) 1300 is in the deformed state and a closed state when the reversible memory metal-based connector (RMMC) 1300 is in its original (or undeformed) state. As shown in FIG. 23, while the reversible memory metal-based connector 1300 is in the deformed (or closed) state, the reversible memory metal-based connector 1300 may grip the electrode tabs of the individual battery cells (e.g., the battery cell 1375) in the battery pack 1350. As such, while the reversible memory metal-based connector 1300 is in the deformed (or closed) state, the reversible memory metal-based connector 1300 may provide an electrical connection between the battery cells (e.g., the battery cell 1375) in the battery pack 1350 such that an electrical current is able to flow therebetween. Contrastingly, when the reversible memory metal-based connector 1300 reverts back to its original (or undeformed) state, the release of the electrode tabs may also decouple the electrical connection between the battery cells in the battery pack 1350. When the reversible memory metal-based connector 1300 is in its original (or undeformed) state, no (or minimal) electrical current may be able to flow between the battery cells in the battery pack 1350.

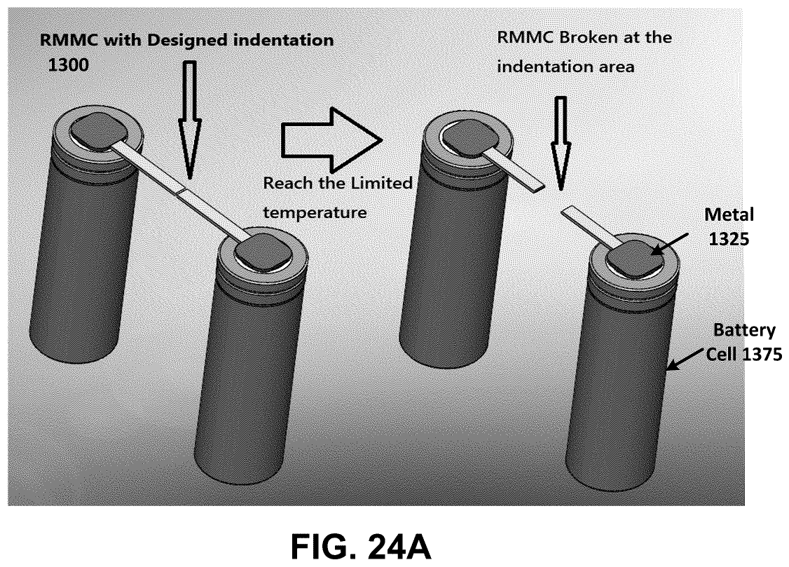

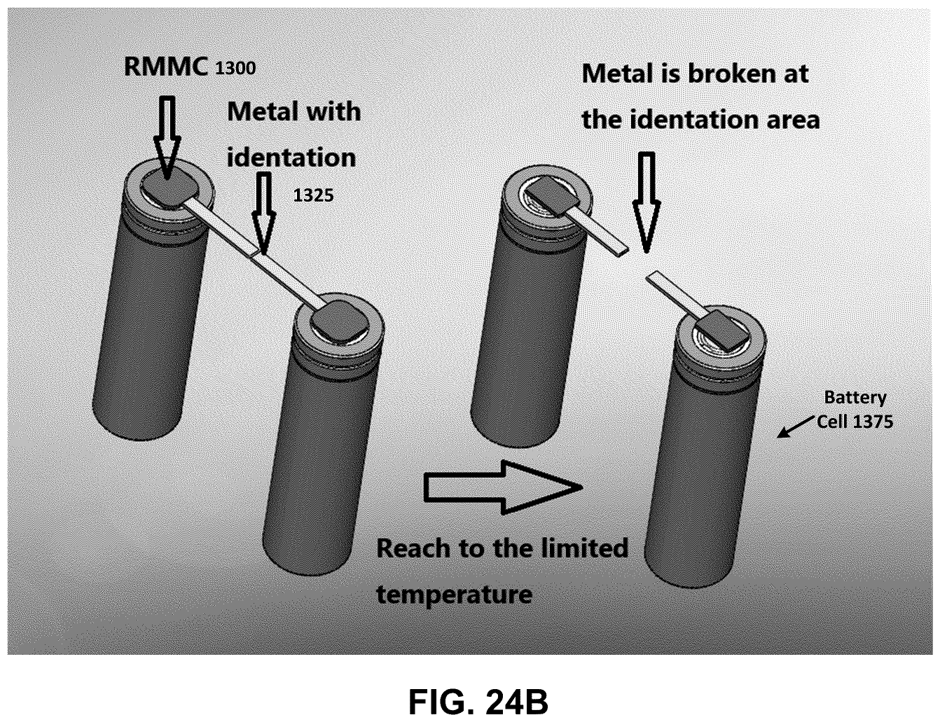

FIG. 24A depicts a perspective view of the battery pack 1350 including another example of the reversible memory metal-based connector (RMMC) 1300, in accordance with some example embodiments. The example of the reversible memory metal-based connector (RMMC) 1300 shown in FIG. 24A is a bar of reversible memory metal secured (e.g., welded) to the electrode tabs of two or more batteries (e.g., the battery cell 1375) in a battery pack (e.g., the battery pack 1350) through metal pieces 1325. In some cases, these metal pieces 1325 may be rendered with non-reversible memory metals. In some cases, the bar of reversible memory metal may undergo deformation in which it is stretched to a length equivalent to the distance between the batteries (or the connection points to the electrode tabs of the batteries) in the battery pack (e.g., battery pack 1350). Moreover, in some cases, the bar of reversible memory metal may include one or more two areas where the metal is rendered weaker (or more prong to breakage) than other areas of the bar. In the example shown in FIG. 24A, for instance, the bar is rendered with an indentation, although other configurations are also possible. While the bar of reversible memory metal is in its deformed state, the bar provides an electrical connection between the battery cells (e.g., the battery cell 1375) in the battery pack (e.g., the battery pack 1350) that enables an electrical current to flow between the battery cells. Contrastingly, FIG. 24A shows that when the bar of reversible memory metal reverts to its original (or undeformed) state upon exposure to heat (e.g., and reaching a threshold or trigger temperature), the bar may shrink or contract. For instance, in some cases, the bar of reversible memory metal may shorten upon exposure to heat (e.g., and reaching a threshold or trigger temperature), thus applying pressure against the weak point (or points) in the bar to cause the bar to break. The breakage of the bar of reversible memory metal when the bar reverts to its original (or undeformed) state at the threshold or trigger temperature may act as a fuse that electrically decouples the battery cells (e.g., the battery 1350) in the battery pack (e.g., the battery cell 1375) such that electrical current is unable to flow therebetween. The bar of reversible memory metal is therefore able to thwart the spread of thermal events in the battery pack (e.g., the battery pack 1375).

FIG. 24B depicts a perspective view of the battery pack 1350 including another example of the reversible memory metal-based connector (RMMC) 1300, in accordance with some example embodiments. The example of the reversible memory metal-based connector (RMMC) 1300 shown in FIG. 24B is a piece of reversible memory metal that is physically coupled (e.g., welded) to the electrode tab of each battery cell (e.g., the battery cell 1375) in the battery pack (e.g., the battery pack 1350). In some cases, the piece of reversible memory metal that is physically coupled with the electrode tab of one battery cell may be further coupled with the piece of reversible memory metal that is physically with the electrode tab of one or more other battery cells in the same battery pack through a metal bar (or wire or rod). As shown in FIG. 24B, the metal bar may be rendered with one or more weak points (e.g., areas in the metal bar that is thinner than others). The contraction of the pieces of reversible memory metal physically coupled with the electrode tab of each battery cell (e.g., the battery cell 1375) when these pieces of reversible memory metal reverts to their original (or undeformed state) upon exposure to heat (e.g., and reaching a threshold or trigger temperature) may cause the metal bar to break at the one or more weak points. As such, in some cases, the combination of the reversible memory metal-based connector 1300 and the metal bar with weak points may serve as a fuse that disrupts the flow of current in the battery pack (e.g., the battery pack 1350) in the event of a thermal event arising from overcharging or overcurrent at one or more battery cells (e.g., the battery cell 1375) in the battery pack.

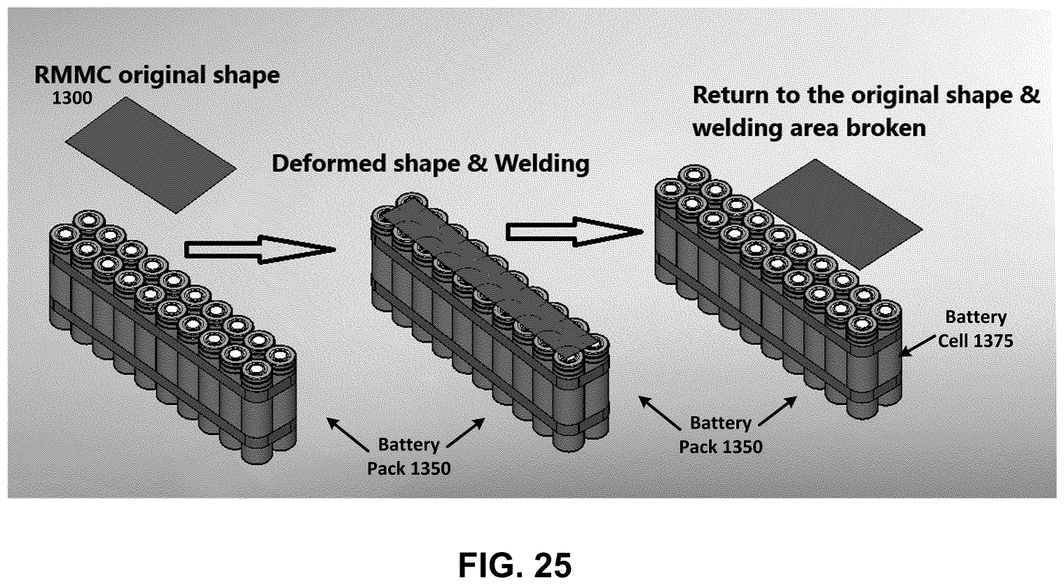

FIG. 25 depicts a perspective view of the battery pack 1350 including another example of the reversible memory metal-based connector (RMMC) 1300, in accordance with some example embodiments. The example of the reversible memory metal-based connector (RMMC) 1300 shown in FIG. 25 is a sheet of reversible memory metal secured (e.g., welded) to the electrode tabs) of two or more batteries (e.g., the battery cell 1375) in a battery pack (e.g., the battery pack 1350). In some cases, the sheet of reversible memory metal may undergo deformation in which it is stretched to a dimension that allows the sheet of reversible memory metal to be physically coupled with the electrode tabs of the batteries (or the connection points to the electrode tabs of the batteries) in the battery pack (e.g., battery pack 1350). In other words, in its deformed state, the sheet of reversible memory metal may be sufficiently large to provide an electrical connection between the battery cells (e.g., the battery cell 1375) in the battery pack 1350). In some cases, the sheet of reversible memory metal may revert to its original (or undeformed) state upon exposure to heat (e.g., and reaching a threshold or trigger temperature). In the example shown in FIG. 25, the sheet of reversible memory metal may contract as it reverts back to its original (or undeformed) state. The contraction of the reversible memory metal may cause the physical coupling (e.g., welding) between the sheet of the reversible memory metal and the electrode tabs of the battery cells (e.g., the battery cell 1375) in the battery pack 1350 to break. The breakage of the physical coupling (e.g., welding) may serve as a fuse that disrupts the flow of current between the battery cells (e.g., the battery cell 1375) in the battery pack 1350, thus thwarting the spread of thermal events in the battery pack 1350.

Table 8 below depicts nine examples of the reversible memory metal-based connector 1300. As noted, the reversible memory metal-based connector 1300 may be configured to have an application-specific activation temperature at which the reversible memory metal-based connector 1300 reverts back to its original (or undeformed) state. The nine examples of the reversible memory metal-based connector 1300 in Table 8 are configured with different activation temperatures. Moreover, as shown, the reversible memory metal-based connector 1300 may exhibit a variety of different dimensions, shape, and composition.

| | Cross | Trigger | | | | |
|---|---|---|---|---|---|---|
| | Section | Temper- | Compo- | | | |
| Example | Dimensions | ature | sition | Shape | Length | |
| 1 | ϕ0.5 | 80 ± 10° C. | Nickel | rod wire | 31 | cm |
| | | | Titanium | | | |
| | | | Alloy | | | |
| 2 | ϕ1 | 15 ± 10° C. | Nickel | rod wire | 153 | cm |
| | | | Titanium | | | |
| | | | Alloy | | | |
| 3 | ϕ1 | 40 ± 10° C. | Nickel | rod wire | 31 | cm |
| | | | Titanium | | | |
| | | | Alloy | | | |
| 4 | ϕ1 | 40 ± 10° C. | Nickel | rod wire | 31 | cm |
| | | | Titanium | | | |
| | | | Alloy | | | |
| 5 | ϕ1 | 80 ± 10° C. | Nickel | rod wire | 18 | cm |
| | | | Titanium | | | |
| | | | Alloy | | | |
| 6 | ϕ2 | 40 ± 10° C. | Nickel | rod wire | 18 | cm |
| | | | Titanium | | | |
| | | | Alloy | | | |
| 7 | ϕ2 | 60 ± 10° C. | Nickel | rod wire | 18 | cm |
| | | | Titanium | | | |
| | | | Alloy | | | |
| 8 | ϕ2 | 80 ± 10° C. | Nickel | rod wire | 31 | cm |
| | | | Titanium | | | |
| | | | Alloy | | | |
| 9 | 2 × 0.8 | 80 ± 10° C. | Nickel | flat wire | 100 | cm |
| | | | Titanium | | | |
| | | | Alloy | | | |

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A battery pack, comprising:
a plurality of battery cells; and
a reversible memory metal-based connector that transitions between a deformed state to an undeformed state in response to a temperature trigger, wherein the reversible memory metal-based connector in the deformed state physically connects two or more of the plurality of battery cells such that an electrical current is able to flow between the two or more battery cells, and wherein the reversible memory-metal based connector in the undeformed state is physically disconnected from the two or more battery cells to disrupt a flow of current between the two or more battery cells.

2. The battery pack of claim 1, wherein the reversible memory metal-based connector comprises a clamp, wherein the clamp is in a closed state when the reversible memory metal-based connector is in the deformed state, and wherein the clamp is in an open state when the reversible metal-based connector is in the undeformed state.

3. The battery pack of claim 1, wherein the reversible memory metal-based connector comprises a coil, wherein the coil is in a coiled state when the reversible memory metal-based connector is in the deformed state, and wherein the coil is in an uncoiled state when the reversible metal memory-based connector is in the undeformed state.

4. The battery pack of claim 1, wherein the reversible memory metal-based connector comprises a tubing, wherein the tubing is in a compressed state when the reversible memory metal-based connector is in the deformed state, and wherein the tubing is in an uncompressed state when the reversible memory metal-based connector is in the undeformed state.

5. The battery pack of claim 1, wherein the reversible memory metal-based connector comprises a bar, wherein the bar is in an uncontracted state when the reversible memory metal-based connector is in the deformed state, wherein the bar is in a contracted state when the reversible memory metal-based connector is in the undeformed state, and wherein the bar includes one or more weak points that breaks when the reversible memory metal-based connector reverts to its undeformed state.

6. The battery pack of claim 1, wherein the plurality of battery cells comprise a plurality of metal ion battery cells.

7. The battery pack of claim 1, wherein the plurality of battery cells comprise a plurality of lithium ion (Li+) battery cells.

8. The battery pack of claim 1, wherein the plurality of battery cells includes at least one battery cell having one or more sacrificial electrodes, and wherein the one or more sacrificial electrodes decompose while the at least one battery cell is in a low-voltage state or a zero-voltage state to prevent a decomposition of a negative current collector in the at least one battery cell.

9. The battery pack of claim 1, wherein the reversible memory metal-based connector in the deformed state physically couples an electrode tab of each of the two or more battery cells, and wherein the reversible memory metal-based connector physically decouples the electrode tab of the two or more battery cells when the reversible memory metal-based connector transitions to the undeformed state.

10. The battery pack of claim 1, wherein the reversible memory metal-based connector in the deformed state is inserted through an aperture in an electrode tab of each of the two or more battery cells.

11. The battery pack of claim 1, wherein the temperature trigger comprises a temperature determined based on a temperature tolerance of an application associated with the battery pack.
